(19) United States
(12) Patent Application Publication
(10) Pub. No.: US 2024/0169860 A1
(43) Pub. Date: May 23, 2024

(54) DENTAL MODEL, DENTAL KIT, AND METHOD

(71) Applicant: 3M INNOVATIVE PROPERTIES COMPANY, St. Paul, MN (US)

(72) Inventors: Katelyn M. Languell, Eagan, MN (US); Joseph C. Dingeldein, Hudson, WI (US); James D. Hansen, White Bear Lake, MN (US); Robert T. McKevett, St. Paul, MN (US); John A. Norris, Woodbury, MN (US); Shane C. Pedersen, St. Paul, MN (US)

(21) Appl. No.: 18/551,996

(22) PCT Filed: Mar. 22, 2022
(86) PCT No.: PCT/IB2022/052597

§ 371 Date: Sep. 22, 2023

Related U.S. Application Data
(60) Provisional application No. 63/200,933, filed on Apr. 5, 2021.

(51) Int. Cl. G09B 23/28

(52) U.S. Cl. CPC G09B 23/283

(57) ABSTRACT

A dental model includes a model dental arch and a plurality of model teeth. The model dental arch includes a first member including a plurality of first openings therethrough, and a second member including a plurality of second openings extending therethrough. The plurality of first openings of the first member and the plurality of second openings of the second member are aligned to each other in a one-to-one correspondence. Each model tooth from the plurality of model teeth includes a tooth portion and a connecting portion extending from the tooth portion. The tooth portion of each model tooth is at least partially and slidably received in a respective first opening from the plurality of first openings. The connecting portion of each model tooth is at least partially received in a respective second opening from the plurality of second openings and detachably retained in the respective second opening.

### TECHNICAL FIELD

The present disclosure relates generally to a dental model, a dental kit, and a method using the dental model.

### BACKGROUND

A dental model is typically used for practicing dentistry. Specifically, a dentist or a dental practitioner may practice a dental treatment on the dental model prior to performing the dental treatment on a patient. The dental model may include one or more model teeth representative of corresponding teeth of the patient. Conventional dental models may not simulate realistic movements of human teeth during an in-vivo procedure. Therefore, such conventional dental models may not be suitable for practicing complex dental treatments.

### SUMMARY

Generally, the present disclosure relates to a dental model. The present disclosure further relates to a dental kit including the dental model, and a method of using the dental model.

In a first aspect, the present disclosure provides a dental model. The dental model includes a model dental arch and a plurality of model teeth. The model dental arch includes a first member representative of a human dental arch. The first member includes a plurality of first openings therethrough. Each of the plurality of first openings extends along a longitudinal axis. The first member further includes a first material having a first elastic modulus. The model dental arch further includes a second member at least partially received within the first member. The second member includes a plurality of second openings extending therethrough. The plurality of first openings of the first member and the plurality of second openings of the second member are aligned to each other in a one-to-one correspondence. The second member includes a second material having a second elastic modulus. The plurality of model teeth corresponds to a plurality of human teeth. Each of the plurality of model teeth includes a tooth portion representative of a corresponding human tooth from the plurality of human teeth and a connecting portion extending from the tooth portion. The tooth portion of each of the plurality of model teeth is at least partially and slidably received in a respective first opening from the plurality of first openings. The connecting portion of each of the plurality of model teeth is at least partially received in a respective second opening from the plurality of second openings and detachably retained in the respective second opening. At least one of: the tooth portion of each of the plurality of model teeth and at least a portion of a surface of the first member forming the respective first opening define a clearance therebetween; and the first elastic modulus of the first material is from about 0.1 MPa to about 5 MPa; such that upon application of a lateral load on each of the plurality of model teeth in a direction substantially perpendicular to the longitudinal axis, each of the plurality of model teeth flexes laterally from at least about 50 microns to at most about 250 microns in the direction substantially perpendicular to the longitudinal axis.

In a second aspect, the present disclosure provides a dental model. The dental model includes a model dental arch and a plurality of model teeth. The model dental arch is representative of a human dental arch. The model dental arch includes a plurality of openings therethrough. Each of the plurality of openings extends along a longitudinal axis. The model dental arch further includes a material having an elastic modulus. The plurality of model teeth corresponds to a plurality of human teeth. Each of the plurality of model teeth includes a tooth portion representative of a corresponding human tooth from the plurality of human teeth and a connecting portion extending from the tooth portion. The tooth portion and the connecting portion of each of the plurality of model teeth is at least partially and slidably received in a respective opening from the plurality of openings. The connecting portion of each of the plurality of model teeth is detachably retained in the respective opening. The tooth portion of each of the plurality of model teeth and at least a portion of a surface of the model dental arch forming the respective opening define a clearance therebetween; or the tooth portion of each of the plurality of model teeth and at least the portion of the surface of the model dental arch forming the respective opening define the clearance therebetween and the elastic modulus of the material is from about 750 MPa to about 20000 MPa; or the elastic modulus of the material is from about 0.1 MPa to about 5 MPa; or the tooth portion of each of the plurality of model teeth and at least the portion of the surface of the model dental arch forming the respective opening define the clearance therebetween and the elastic modulus of the material is from about 0.1 MPa to about 5 MPa; such that upon application of a lateral load on each of the plurality of model teeth in a direction substantially perpendicular to the longitudinal axis, each of the plurality of model teeth flexes laterally from at least about 50 microns to at most about 250 microns in the direction substantially perpendicular to the longitudinal axis.

In a third aspect, the present disclosure provides a dental kit for practicing composite dental restoration. The kit includes the dental model of the first aspect. The kit further includes one or more dental matrices configured to couple with at least one of the plurality of model teeth to form a mold cavity enclosing at least a part of the at least one of the plurality of model teeth.

In a fourth aspect, the present disclosure provides a method of using the dental model of the first aspect. The method includes acquiring a three-dimensional representation of an oral cavity of a patient. The method further includes additively forming the model dental arch based on at least the three-dimensional representation. The method further includes additively forming the plurality of model teeth based on at least the three-dimensional representation. The method further includes detachably coupling the plurality of model teeth to the model dental arch to form the dental model. The method further includes practicing composite dental restoration using one or more dental matrices on the dental model.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 illustrates a schematic perspective view of an exemplary human dental arch of a patient;

FIG. 2A illustrates a schematic perspective view of a dental model according to an embodiment of the present disclosure;

FIG. 2B illustrates an exploded view of the dental model of FIG. 2A according to an embodiment of the present disclosure;

FIG. 3A illustrates a schematic perspective view of a first member of the dental model according to an embodiment of the present disclosure;

FIG. 3B illustrates a schematic top view of the first member of FIG. 3A;

FIG. 3C illustrates a schematic bottom view of the first member of FIG. 3A;

FIG. 3D illustrates a schematic block diagram depicting one or more coatings on the first member of FIG. 3A according to an embodiment of the present disclosure;

FIG. 4A illustrates a schematic perspective view of a second member of the dental model according to an embodiment of the present disclosure;

FIG. 4B illustrates a schematic bottom view of the second member of FIG. 4A;

FIG. 4C illustrates a schematic cross-sectional view of the second member of FIG. 4A;

FIG. 4D illustrates a schematic perspective view of a second member of the dental model according to another embodiment of the present disclosure;

FIG. 4E illustrates a schematic perspective view of a second member of the dental model according to another embodiment of the present disclosure;

FIG. 5A illustrates a schematic perspective view of a plurality of model teeth according to an embodiment of the present disclosure;

FIG. 5B illustrates a schematic side view of a model tooth from the plurality of model teeth according to an embodiment of the present disclosure;

FIG. 5C illustrates a schematic perspective view of a model tooth from the plurality of model teeth according to another embodiment of the present disclosure;

FIGS. 6A and 6B illustrate schematic cross-sectional views of the model tooth received in the model dental arch according to an embodiment of the present disclosure;

FIG. 7A illustrates a side view of a model dental arch according to another embodiment of the present disclosure;

FIG. 7B illustrates a bottom view of the model dental arch of FIG. 7A;

FIG. 8A illustrates a schematic perspective view of a dental model according to another embodiment of the present disclosure;

FIG. 8B illustrates a perspective exploded view of the dental model of FIG. 8A according to an embodiment of the present disclosure;

FIG. 9A illustrates a schematic top view of the model dental arch of FIG. 8A;

FIG. 9B illustrates a schematic bottom view of the model dental arch of FIG. 8A;

FIG. 9C illustrates a schematic cross-sectional view of the model dental arch of FIG. 8A;

FIG. 9D illustrates a schematic block diagram depicting one or more coatings on the model dental arch of FIG. 8A according to an embodiment of the present disclosure;

FIG. 10A illustrates a schematic top view of the model dental arch of FIG. 8A according to another embodiment of the present disclosure;

FIG. 10B illustrates a schematic perspective view of the model dental arch of FIG. 8A according to another embodiment of the present disclosure;

FIGS. 11A and 11B illustrate schematic cross-sectional views of the model tooth received in the model dental arch according to another embodiment of the present disclosure;

FIG. 12A illustrates a side view of a model dental arch according to another embodiment of the present disclosure;

FIG. 12B illustrates a bottom view of the model dental arch of FIG. 12A according to another embodiment of the present disclosure;

FIG. 13 illustrates a schematic block diagram of a dental kit according to an embodiment of the present disclosure;

FIG. 14 illustrates a dental matrix coupled with a model tooth according to an embodiment of the present disclosure;

FIG. 15 illustrates a flowchart of a method of using the dental model according to an embodiment of the present disclosure; and

FIGS. 16A-16E illustrate schematic views of various steps of using the dental model according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

As used herein, “at least one of A and B” should be understood to mean “only A, only B, or both A and B”.

As used herein, the term “dental restorative material” refers to a material or means for restoring the function of a missing tooth structure. Dental restorative material may include dental filling materials. The dental restorative material may be used, for example, to restore a missing tooth structure following external trauma or as part of a restorative treatment for dental caries, or tooth decay.

As used herein, then term “composite dental restoration” refers to a procedure of placing and shaping composite materials onto the surface of a tooth or into a prepared tooth of a patient to restore the function or enhance the aesthetics of a tooth. The composite materials may harden after being applied to the tooth and achieve aesthetic and functional properties similar to tooth enamel and/or dentin. Composite dental restoration may include synthetic materials that combine polymeric matrix with a dispersion of glass, mineral, ceramic or resin filler particles and/or short fibers. Performance of these materials may be enhanced with coupling agents to optimize handling properties of the composite and enhance chemical bonding of the filler and resin. Composite restorative materials may include glass ionomer and may be cured by light and/or chemical initiators.

As used herein, the term “direct dental restoration” refers to a procedure of placing and shaping soft or malleable dental filling materials onto a tooth or into a prepared tooth of a patient to restore the function of a missing tooth structure. Chemical etching and/or application of a dental adhesive may precede composite placement. The soft or malleable dental filling materials are placed directly on the prepared tooth. The soft or malleable dental filling materials may harden after being applied to the prepared tooth, thereby restoring the function of the missing tooth structure.

As used herein, the term “three-dimensional representation” refers to any three-dimensional surface map of an object, such as a point cloud of surface data, a set of two-dimensional polygons, or any other data representing all or some of the surface of an object, as might be obtained through the capture and/or processing of three-dimensional scan data, unless a different meaning is explicitly provided or otherwise clear from the context. A “three-dimensional representation” may include volumetric and other representations unless a different meaning is explicitly provided or otherwise clear from the context.

As used herein, the term “tooth ankylosis” refers to a fusion between alveolar bone and the cementum of teeth. Tooth ankylosis may be caused by genetic predisposition, local metabolic changes, dental trauma, or replantation of avulsed teeth.

As used herein, the term “periodontitis” refers to a severe gum infection that may lead to tooth loss and other serious health complications. Periodontitis may cause damage to the gum tissue, and without treatment, may damage the alveolar bone.

As used herein, the term “gingival sulcus” refers to a space between a tooth and gingival tissues surrounding the tooth.

As used herein, the term “dental matrices” refers to range of non-custom or custom tools from which a clinician chooses an appropriate size/shape for a tooth being restored. Custom tools may be inserted into a gingival sulcus of a patient's tooth to isolate the tooth from blood and saliva to permit a composite dental restoration to be formed near or across the gum line. Dental matrices may be placed around at least a portion of the tooth being restored. The dental matrices may be a metallic or plastic strip, and when the dental matrices are placed around at least a portion of the tooth being restored, the dental matrices may act as a form for the desired shape of the restored tooth. Dental matrices may create separation between interproximal surface of the tooth being restored and an interproximal surface of a second tooth adjacent the tooth being restored. Dental matrices may further allow for the composite dental restoration of multiple teeth at once.

The present disclosure provides a dental model, a dental kit including the dental model, and a method of using the dental model. The dental model, the dental kit, and the method may be used for practicing a dental procedure prior to the dental procedure in-vivo. In other words, the dental model may be used for practicing dentistry and/or orthodontics. The dental model may further be used for training of the dental procedure. The dental model may further be used for demonstration purposes, for example, demonstration of commercial dental products.

The dental model includes a model dental arch and a plurality of model teeth. The model dental arch includes a first member and a second member. The model dental arch includes a first member representative of a human dental arch and including a plurality of first openings therethrough. Each of the plurality of first openings extends along a longitudinal axis. The first member includes a first material having a first elastic modulus. The model dental arch further includes a second member at least partially received within the first member. The second member includes a plurality of second openings extending therethrough. The plurality of first openings of the first member and the plurality of second openings of the second member are aligned to each other in a one-to-one correspondence. The second member includes a second material having a second elastic modulus. The plurality of model teeth corresponds to a plurality of human teeth. Each of the plurality of model teeth includes a tooth portion representative of a corresponding human tooth from the plurality of human teeth and a connecting portion extending from the tooth portion. The tooth portion of each of the plurality of model teeth is at least partially and slidably received in a respective first opening from the plurality of first openings. The connecting portion of each of the plurality of model teeth is at least partially received in a respective second opening from the plurality of second openings and detachably retained in the respective second opening. At least one of: the tooth portion of each of the plurality of model teeth and at least a portion of a surface of the first member forming the respective first opening define a clearance therebetween; and the first elastic modulus of the first material is from about 0.1 MPa to about 5 MPa; such that upon application of a lateral load on each of the plurality of model teeth in a direction substantially perpendicular to the longitudinal axis, each of the plurality of model teeth flexes laterally from at least about 50 microns to at most about 250 microns in the direction substantially perpendicular to the longitudinal axis.

In another embodiment of the present disclosure, a dental model includes a model dental arch and a plurality of model teeth. The model dental arch is representative of a human dental arch and including a plurality of openings therethrough. Each of the plurality of openings extends along a longitudinal axis. The model dental arch includes a material having an elastic modulus. The plurality of model teeth corresponds to a plurality of human teeth. Each of the plurality of model teeth includes a tooth portion representative of a corresponding human tooth from the plurality of human teeth and a connecting portion extending from the tooth portion. The tooth portion and the connecting portion of each of the plurality of model teeth is at least partially and slidably received in a respective opening from the plurality of openings. The connecting portion of each of the plurality of model teeth is detachably retained in the respective opening. The tooth portion of each of the plurality of model teeth and at least a portion of a surface of the model dental arch forming the respective opening define a clearance therebetween; or the tooth portion of each of the plurality of model teeth and at least the portion of the surface of the model dental arch forming the respective opening define the clearance therebetween and the elastic modulus of the material is from about 750 MPa to about 20000 MPa; or the elastic modulus of the material is from about 0.1 MPa to about 5 MPa; or the tooth portion of each of the plurality of model teeth and at least the portion of the surface of the model dental arch forming the respective opening define the clearance therebetween and the elastic modulus of the material is from about 0.1 MPa to about 5 MPa; such that upon application of a lateral load on each of the plurality of model teeth in a direction substantially perpendicular to the longitudinal axis, each of the plurality of model teeth flexes laterally from at least about 50 microns to at most about 250 microns in the direction substantially perpendicular to the longitudinal axis.

The dental kit of the present disclosure includes the dental model and one or more dental matrices configured to couple with at least one of the plurality of model teeth to form a mold cavity enclosing at least a part of the at least one of the plurality of model teeth.

The method of the present disclosure includes acquiring a three-dimensional representation of an oral cavity of a patient. The method further includes additively forming the model dental arch based on at least the three-dimensional representation. The method further includes additively forming the plurality of model teeth based on at least the three-dimensional representation. The method further includes detachably coupling the plurality of model teeth to the model dental arch to form the dental model. The method further includes practicing composite dental restoration using one or more dental matrices on the dental model.

A composite dental restoration procedure may involve cutting a tooth to remove portions of the tooth (commonly referred to as “preparing” the tooth). In some cases, the composite dental restoration procedure may involve cutting a decayed or structurally unsound portion of the tooth. The removed portions of the tooth may be filled with the composite dental restoration material.

The composite dental restoration procedure may typically utilize a conventional dental matrix. A dentist may select an appropriate shape and size of the conventional dental matrix according to a tooth surface of a tooth of a patient to be restored. The dental matrix may be inserted into a gingival sulcus of the tooth of the patient to isolate the tooth from blood and saliva. Further, in some cases, a wedge may be inserted between adjacent teeth of the patient to increase separation between the adjacent teeth by at least a thickness of the dental matrix.

Alternatively, a custom dental matrix may allow restoration of multiple teeth of the patient at once. Unlike the conventional dental matrix, the custom dental matrix may not require wedging between the adjacent teeth to increase the gingival sulcus. Instead, the custom dental matrix may be digitally designed to be precisely placed around the tooth of the patient for the composite dental restoration.

The dental model may include model teeth to simulate the dental arch of the patient. A realistic simulation of the composite dental restoration on the dental model may require careful management of lateral flexure of the model teeth upon application of lateral loads on the model teeth (e.g., in order to wedge the model teeth).

Conventional dental models may include conventional model teeth coupled to the conventional dental model by screwthread connections. The screwthread connections may be inaccessible without disassembling components of the conventional dental model. Therefore, it may be time consuming to replace the conventional model teeth. Furthermore, additional assembly of the components of the conventional dental model may be required after replacement of the conventional model teeth. This may further consume time of a user.

Typically, the conventional dental models fail to simulate a human dental arch. Specifically, the model teeth of the conventional dental model may not simulate realistic movements of human teeth during an in-vivo procedure. As discussed above, the model teeth may be fixedly retained in the conventional dental model by the screwthread connections, or any other conventional attachment mechanisms. Therefore, the model teeth of the conventional dental model may cause interference in placement of the dental matrix. Further, the conventional model teeth may move unrealistically during placement of the dental matrix. Mobility and movement of the conventional model teeth of the conventional dental model may not be adequate for the realistic simulation of the composite dental restoration, as the mobility of the conventional model teeth has to be adjusted by the user in the conventional dental model. Further, the simulation becomes highly variable and dependent on the operator using the typodont.

The dental model, the dental kit, and the method may allow a dentist to practice certain dental treatments on the dental model before performing an in-vivo procedure on the patient. The dental model may have the plurality of model teeth composed of materials that allow drilling cavities. The plurality of model teeth may further allow filling the cavities with the dental restorative material, such as amalgam or composite. In some cases, the dental model may also allow the dentist to practice indirect restoration, such as for crowns and bridges. Further, the dental model according to the present disclosure may provide a realistic simulation of the human dental arch. Therefore, the dental model of the present disclosure may allow a realistic simulation of the composite dental restoration for the in-vivo procedure. Specifically, the dental model may simulate realistic movements of the plurality of human teeth.

The dental model and the dental kit of the present disclosure may further be customizable. In some cases, the dental model and the dental kit may also be patient specific. Further, the dental kit may include the one or more dental matrices for practicing the composite dental restoration. As discussed above, the dental model may provide realistic simulation of the human dental arch. Therefore, the one or more dental matrices may be precisely placed and register to the fine features of the dental model accurately. This may prevent leakage of the dental restorative material and damages to the one or more dental matrices during practice of the composite dental restoration. The first member of the model dental arch of the dental model may be made from a material having a low elastic modulus to simulate soft tissues of human gingiva and to simulate realistic movements of the human teeth of the human dental arch. Further, a flexibility, retention, and mobility of each of the plurality of model teeth may be adjusted by changing geometries of the first and second members of the model dental arch and/or a geometry of each of the plurality of model teeth. Unlike the conventional dental model, movement of the model teeth are engineered into the dental model. Further, each of the plurality of model teeth of the dental model may be made from a material having a high elastic modulus to simulate the human teeth.

The dental model, the dental kit, and the method according to the present disclosure may further reduce a time consumed in assembling and disassembling the dental model. In other words, each of the plurality of model teeth may be quickly removed from the model dental arch when desired. For example, each of the plurality of model teeth may be snap-fitted in the first and second members of the model dental arch to facilitate quick attachment and removal of the plurality of model teeth. Further, one or more coatings may be applied on the model dental arch that may facilitate removing cured composite excess from the model dental arch to mimic the behavior in-vivo. Further, the one or more coatings may prevent the cured composite excess from bonding to the dental model when curing. Thus, the dental model may be reusable, and simulate the in-vivo procedure.

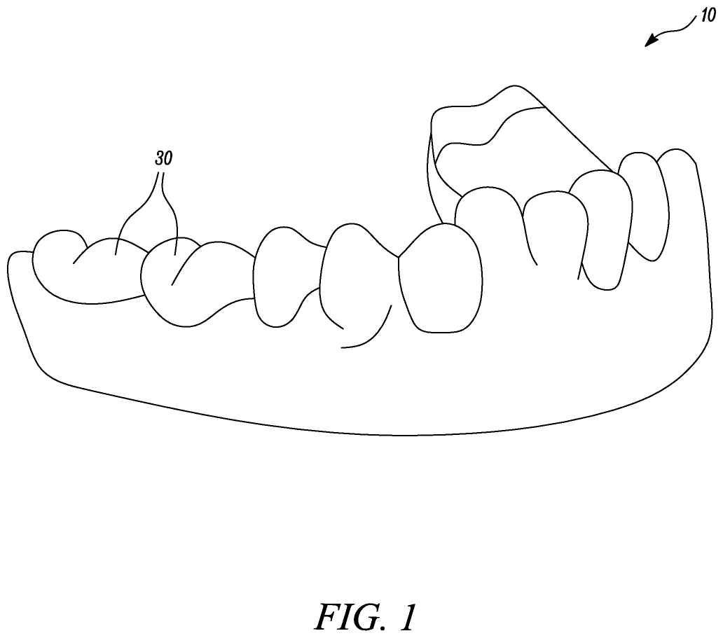

Referring now to the figures, FIG. 1 illustrates a schematic perspective view of a human dental arch 10 of a patient undergoing a dental treatment. The human dental arch 10 includes a plurality of human teeth 30. The plurality of human teeth 30 may include one or more of a central incisor, a lateral incisor, a canine, a premolar, a first molar, a second molar, and a third molar. The human dental arch 10 shown in FIG. 1 is a lower dental arch of the patient. However, the plurality of human teeth 30 may be of the lower dental arch and/or an upper dental arch of the patient.

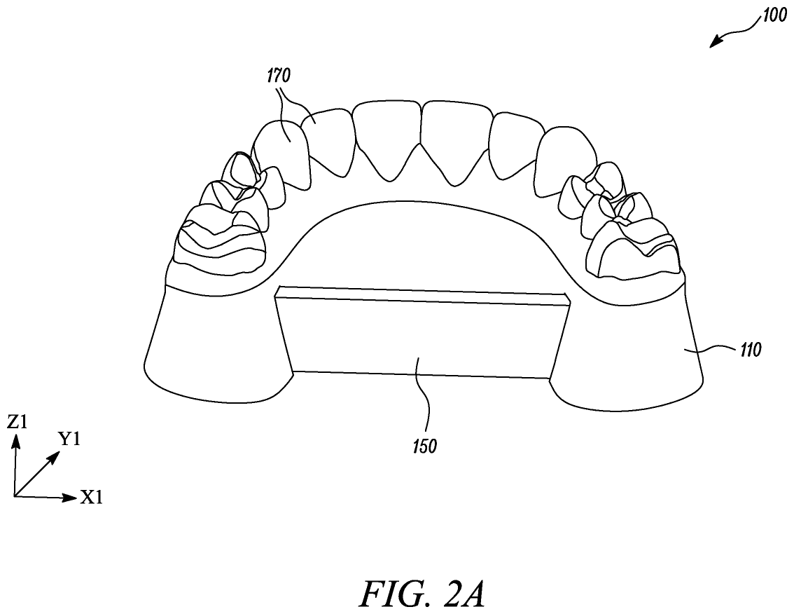

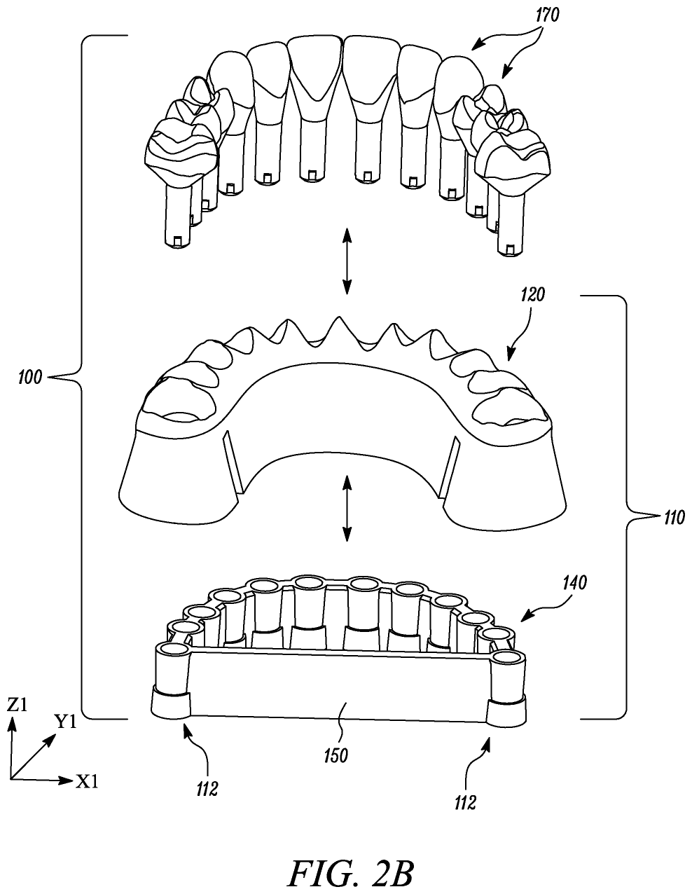

FIGS. 2A and 2B illustrate a dental model 100 according to an embodiment of the present disclosure. The dental model 100 defines mutually orthogonal X1, Y1, and Z1-axes. The X1 and Y1-axes are in-plane axes of the dental model 100, while the Z1-axis is a transverse axis disposed along a thickness of the dental model 100. In other words, the X1 and Y1-axes are disposed along a plane of the dental model 100, while the Z1-axis is perpendicular to the plane of the dental model 100.

The dental model 100 may be representative of the human dental arch 10 (shown in FIG. 1) of the patient. In some embodiments, the dental model 100 may be representative of only a portion of the human dental arch 10, such as a quadrant of the human dental arch 10. Therefore, the dental model 100 may provide important information about one or more human teeth 30 of the patient to aid in planning the dental treatment, such as an oral surgery, a dental restoration, and the like. The dental model 100 may be fabricated using a suitable process, depending upon desired application attributes. In some embodiments, the dental model 100 is patient specific and additively formed. In some other embodiments, the dental model 100 may be fabricated using injection molding. That is, in some embodiments, the dental model 100 is injection molded. The dental model 100 may further be used for training of the dental treatment. The dental model may further be used for demonstration purposes, for example, demonstration of commercial dental products.

Referring to FIGS. 2A and 2B, the dental model 100 includes a model dental arch 110. The model dental arch 110 may have an arch-shape. Specifically, the model dental arch 110 may have an arch-shape corresponding to the human dental arch 10 (shown in FIG. 1) of the patient. In some embodiments, the model dental arch 110 may have an arch-shape corresponding to a portion of the human dental arch 10 represented by the dental model 100.

In the illustrated embodiment of FIGS. 2A and 2B, the model dental arch 110 includes a first member 120 and a second member 140 (shown in FIG. 2B). The first member 120 is representative of the human dental arch 10 (shown in FIG. 1). Further, the second member 140 is at least partially received within the first member 120. In some embodiments, the first member 120 and the second member 140 of the model dental arch 110 are formed as a single integral part. However, in some other embodiments, the first member 120 and the second member 140 of the model dental arch 110 are formed separately. Therefore, in some embodiments, the first member 120 and the second member 140 are slidably coupled to each other.

The dental model 100 further includes a plurality of model teeth 170 corresponding to the plurality of human teeth 30 (shown in FIG. 1). Each of the plurality of model teeth 170 may be representative of a corresponding human tooth from the plurality of human teeth 30. The plurality of model teeth 170 may be detachably received in each of the first and second members 120, 140.

In some embodiments, the dental model 100 further includes a bridge member 150 connected to two or more spaced apart locations 112 on the model dental arch 110. In the illustrated embodiment of FIGS. 2A and 2B, the bridge member 150 is connected to two spaced apart locations 112 on the model dental arch 110. The bridge member 150 may be connected to the two or more spaced apart locations 112 on the model dental arch 110 to provide improved stability and rigidity to the model dental arch 110. In the illustrated embodiment of FIG. 2B, the bridge member 150 is connected to the two or more spaced apart locations 112 on the second member 140 of the model dental arch 110. In some other embodiments, the bridge member 150 may be connected to two or more spaced apart locations on the first member 120 of the model dental arch 110.

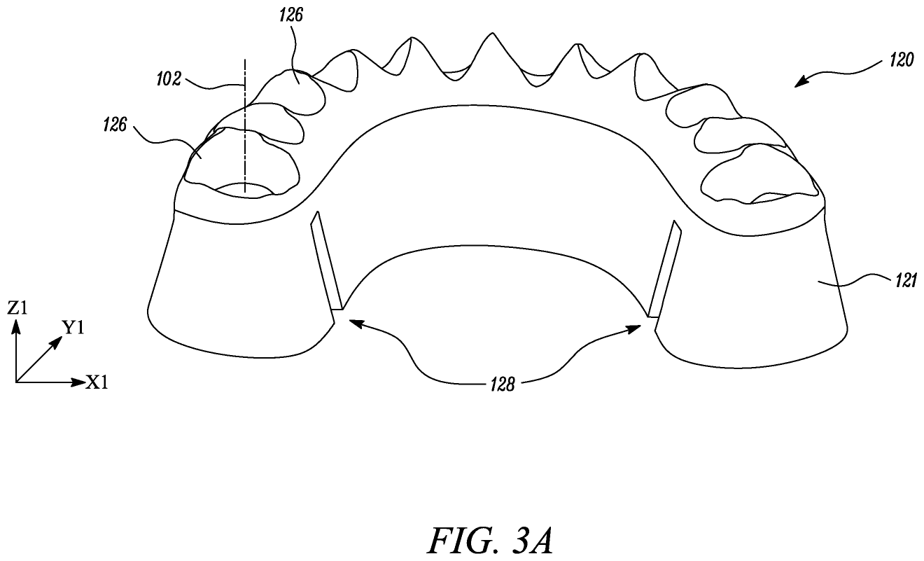

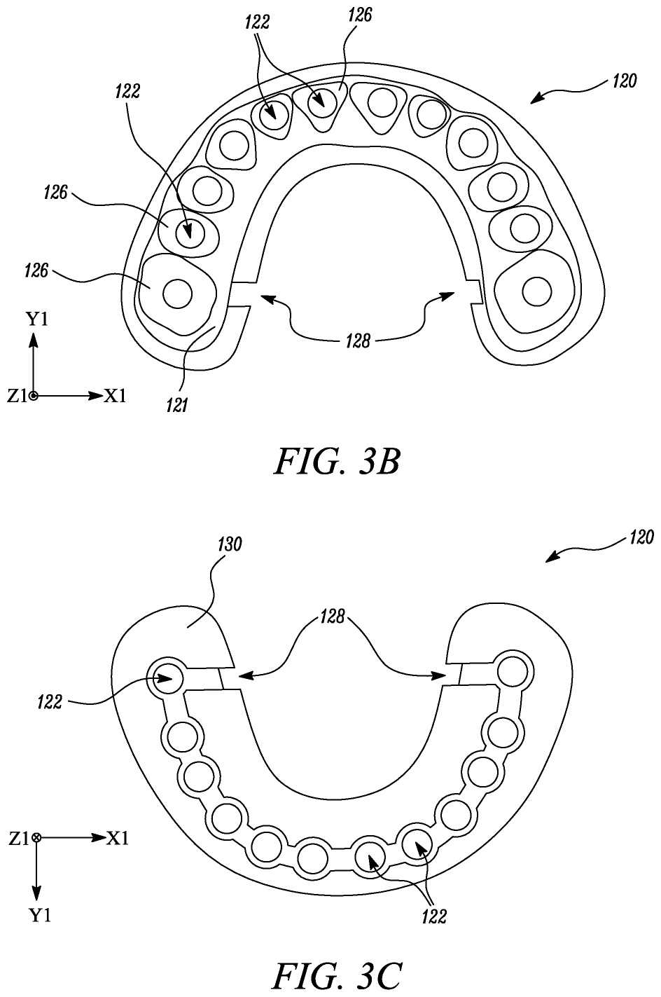

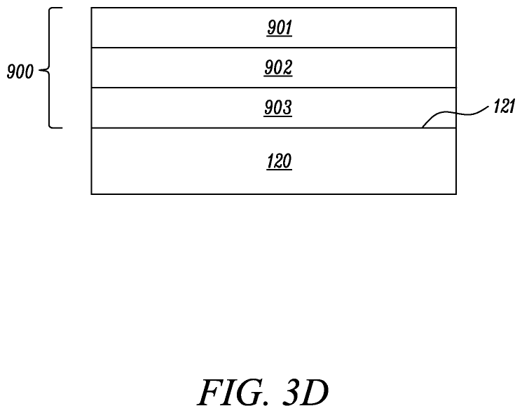

FIGS. 3A, 3B, and 3C illustrate a perspective view, a top view, and a bottom view, respectively, of the first member 120, according to an embodiment of the present disclosure. The first member 120 includes an outer surface 121. Referring to FIGS. 3A-3C, the first member 120 includes a plurality of first openings 122 therethrough. Each of the plurality of first opening 122 extends along a longitudinal axis 102. In some embodiments, each of the plurality of first openings 122 may extend substantially along the Z1-axis. In other words, the longitudinal axis 102 may be substantially parallel to the Z1-axis. In the illustrated embodiment of FIGS. 3B and 3C, at least a portion of each of the plurality of first openings 122 has a substantially circular shape. Further, a shape of each first opening 122 may vary along the respective longitudinal axis 102. However, each of the plurality of first openings 122 may have any suitable shape, such as a semicircular shape, a triangular shape, a rectangular shape, a square shape, a polygonal shape, an elliptical shape, an oval shape, a shape corresponding to natural tooth contours, an irregular shape, and so forth.

The first member 120 further includes a plurality of surfaces 126 corresponding to the plurality of first openings 122. Each surface 126 from the plurality of surfaces 126 forms a respective first opening 122 from the plurality of first openings 122. In other words, each first opening 122 is defined by a corresponding surface 126. In some embodiments, the outer surface 121 of the first member 120 includes the plurality of surfaces 126.

As shown in FIG. 3C, in some embodiments, the first member 120 defines a plurality of coupling channels 128. In some embodiments, each of the plurality of coupling channels 128 is configured to at least partially receive the bridge member 150 (shown in FIGS. 2A and 2B) therein. In some embodiments, each of the plurality of coupling channels 128 may correspond to the two or more spaced apart locations 112 (shown in FIG. 2B) on the second member 140 of the model dental arch 110 to at least partially receive the bridge member 150 therein.

In some embodiments, the model dental arch 110 (shown in FIGS. 2A and 2B) further includes a bottom surface 130. Specifically, the first member 120 may further include the bottom surface 130. In some embodiments, the bottom surface 130 of the first member 120 may be substantially parallel to a plane perpendicular to the Z1-axis. In other words, the bottom surface 130 of the first member 120 may be substantially disposed in the X1-Y1-plane.

The first member 120 further includes a first material having a first elastic modulus. In some embodiments, the first material may simulate soft tissues of human gingiva. The first elastic modulus of the first material is from about 0.1 Mega Pascals (MPa) to about 5 MPa. In some embodiments, the first elastic modulus of the first material may be less than about 5 MPa, and greater than 0.1 MPa, greater than 0.2 MPa, greater than 0.3 MPa, or greater than 0.4 MPa. In some embodiments, the first elastic modulus of the first material may be less than 5 MPa, less than 4 MPa, less than 3 MPa, or less than 2 MPa.

FIG. 3D illustrates a schematic block diagram showing one or more coatings 900 disposed on the first member 120 according to an embodiment of the present disclosure. In some embodiments, the dental model 100 (shown in FIGS. 2A and 2B) further includes the one or more coatings 900 disposed at least partly on the outer surface 121 of the first member 120. In the illustrated embodiment of FIG. 3D, the one or more coatings 900 includes a first coating 901, a second coating 902, and a third coating 903. The first, second and third coatings 901, 902, 903 may be similar to or different from each other. The one or more coatings 900 may include, for example, resins. In some embodiments, the one or more coatings 900 may provide ease in cleaning of the first member 120. Therefore, the one or more coatings 900 may facilitate preparation of the first member 120 for reuse. Thus, the dental model 100 may be reusable. In some embodiments, the one or more coatings 900 may be disposed at least partly on the outer surface 121 of the first member 120 to improve surface properties of the outer surface 121 (e.g., reduction in surface roughness and reduction in flaking). In some embodiments, the one or more coatings 900 may allow removal of a dental restorative material that may be cured on the outer surface 121 of the first member 120.

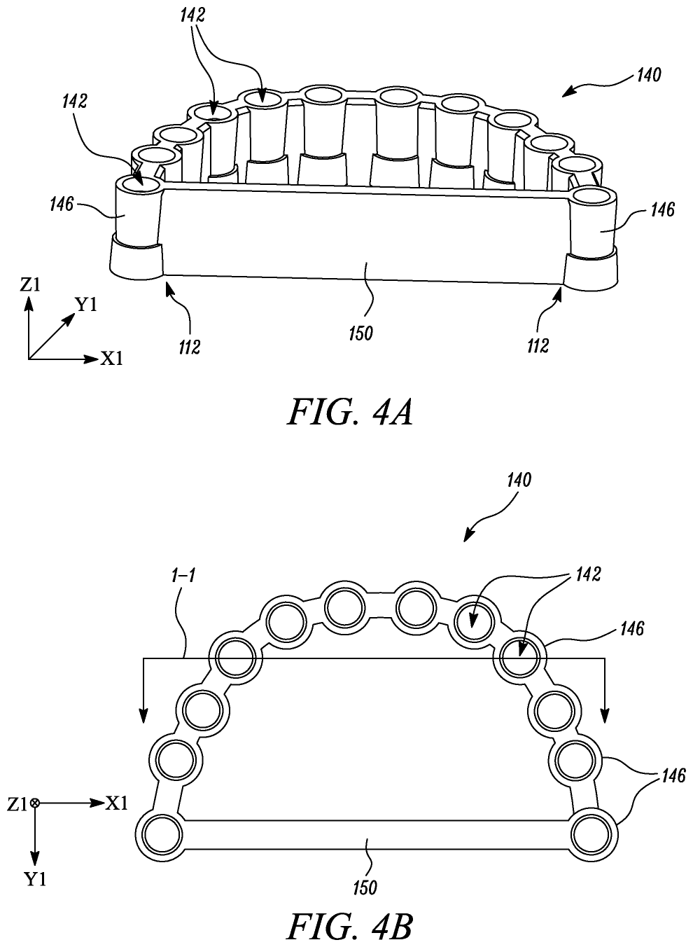

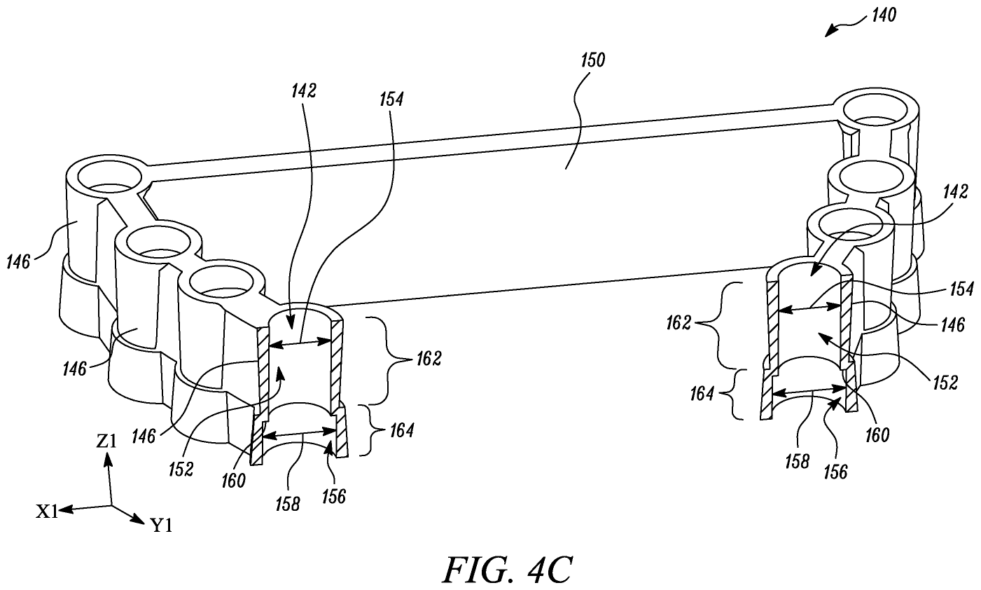

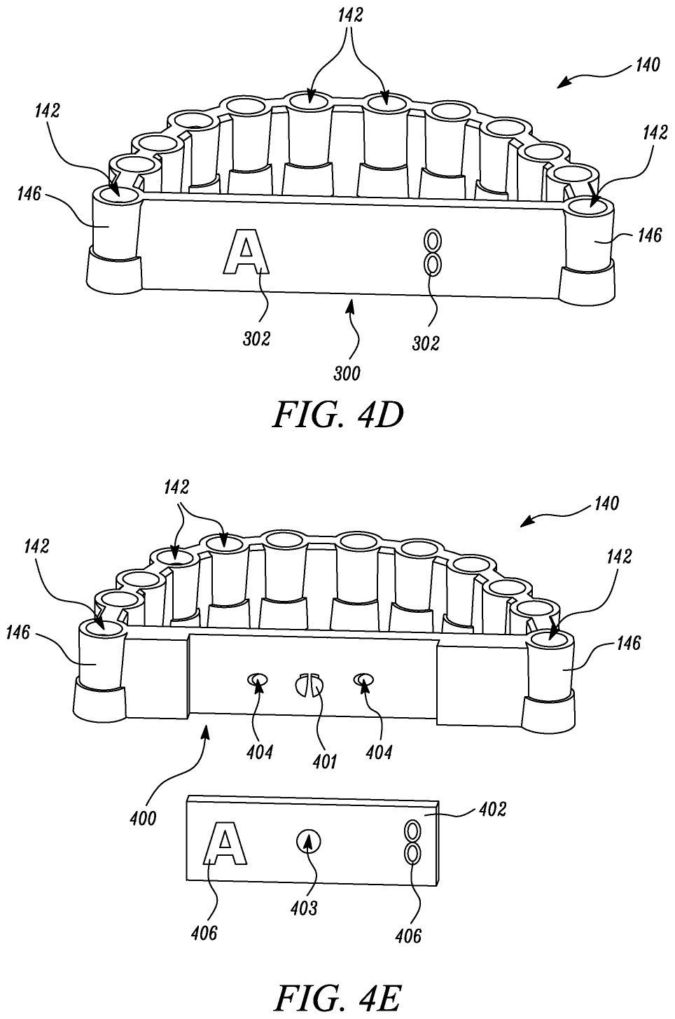

FIGS. 4A and 4B illustrate a perspective view and a top view, respectively, of the second member 140, according to an embodiment of the present disclosure.

Referring to FIGS. 4A and 4B, the second member 140 includes a plurality of second openings 142 extending therethrough. In some embodiments, each of the plurality of second openings 142 may extend substantially along the Z1-axis. In the illustrated embodiment of FIGS. 4A and 4B, each of the plurality of second openings 142 has a circular shape. However, each of the plurality of second openings 142 may have any suitable shape, such as, a semicircular shape, a triangular shape, a rectangular shape, a square shape, a polygonal shape, an elliptical shape, an oval shape, a shape based on natural tooth anatomy, and so forth, as per desired application attributes.

The plurality of first openings 122 (shown in FIGS. 3B and 3C) of the first member 120 (shown in FIGS. 3A-3C) and the plurality of second openings 142 of the second member 140 are aligned to each other in a one-to-one correspondence. In other words, each first opening 122 of the first member 120 may be aligned with a respective second opening 142 of the second member 140. In some embodiments, each of the plurality of second openings 142 may have the shape corresponding to the shape of at least a portion of the respective first opening 122.

In some embodiments, the second member 140 further includes a plurality of tubular segments 146 corresponding to the plurality of second openings 142. Each tubular segment 146 may at least partially define the corresponding second opening 142. Each tubular segment 146 is at least partially received within the respective first opening 122 (shown in FIGS. 3B and 3C) from the plurality of first openings 122. Each of the plurality of tubular segments 146 may extend substantially along the Z1-axis. In some embodiments, the plurality of tubular segments 146 may have a shape corresponding to the shape of at least a portion of the respective first opening 122 from the plurality of first openings 122.

As discussed above, in some embodiments, the dental model 100 includes the bridge member 150. Specifically, in some embodiments, the second member 140 of the dental model 100 further includes the bridge member 150. In some embodiments, the bridge member 150 has an elongate rectangular shape. However, in some other embodiments, the bridge member 150 may have any suitable shape, as per desired application attributes. In some embodiments, the bridge member 150 may extend substantially along the X1-axis. Further, in some embodiments, the bridge member 150 and the second member 140 are formed as a single integral part. However, in some other embodiments, the second member 140 and the bridge member 150 may be formed as two separate parts coupled to each other. In such embodiments, the second member 140 and the bridge member 150 may be coupled to each other using a snap-in fit, a slidable coupling, a bolt, an adhesive, and the like. In other words, the second member 140 and the bridge member 150 may be snap-fitted, slidably coupled to each other, bolted together, or bonded together.

The second member 140 includes a second material having a second elastic modulus. In some embodiments, the second elastic modulus is equal to about the first elastic modulus. In some embodiments, the second elastic modulus of the second material is from about 750 MPa to about 20000 MPa. In some embodiments, the second elastic modulus of the second material may be greater than 300 MPa, greater than 500 MPa, greater than 750 MPa, greater than 1000 MPa, or greater than 1250 MPa. In some embodiments, the second elastic modulus of the second material may be greater than about 300 MPa, and less than 20000 MPa, less than 18000 MPa, less than 16000 MPa, or less than 14000 MPa. In some embodiments, the second elastic modulus of the second material may be from about 1000 MPa to about 16000 MPa.

FIG. 4C illustrates a perspective cross-sectional view of the second member 140, taken generally along line 1-1 of FIG. 4B. In some embodiments, each of the plurality of second openings 142 includes a first portion 152 having a first width 154. In some embodiments, each of the plurality of second openings 142 further includes a second portion 156 disposed adjacent to the first portion 152 and having a second width 158. In some embodiments, the second width 158 of the second portion 156 is greater than the first width 154 of the first portion 152. Further, in some embodiments, the second member 140 further includes a plurality of retaining surfaces 160 corresponding to the plurality of second openings 142. Furthermore, each retaining surface 160 extends between the first portion 152 and the second portion 156 of the corresponding second opening 142.

In the illustrated embodiment of FIG. 4C, each tubular segment 146 includes a narrow part 162 defining the first portion 152 of the respective second opening 142 from the plurality of second openings 142. Each tubular segment 146 further includes a wide part 164 defining the second portion 156 of the respective second opening 142.

Referring to FIGS. 3A-4C, in some embodiments, the second elastic modulus of the second material may be substantially equal to the first elastic modulus of the first material. In some other embodiments, a ratio of the second elastic modulus of the second material to the first elastic modulus of the first material is at least about 10. In some embodiments, the ratio of the second elastic modulus of the second material to the first elastic modulus of the first material may be at least about 150, at least about 200, or at least about 250. In some embodiments, the ratio of the second elastic modulus of the second material to the first elastic modulus of the first material is from about 150 to about 200000.

FIG. 4D illustrates the second member 140 of the model dental arch 110 (shown in FIGS. 2A and 2B) according to an embodiment of the present disclosure. In the illustrated embodiment of FIG. 4D, the second member 140 includes a bridge member 300. The bridge member 300 may be substantially equivalent to the bridge member 150 shown in FIGS. 4A and 4B. However, the bridge member 300 further includes one or more indications 302 for identification of the dental model 100 (shown in FIGS. 2A and 2B). In some cases, the dental model 100 may be patient specific. Therefore, the one or more indications 302 may be used to identify the dental model 100 made specifically for a patient. In some embodiments, the one or more indications 302 may be used to indicate a configuration of the model teeth 170 (shown in FIGS. 2A and 2B) for non-custom or off-the-shelf dental models. For example, the one or more indications 302 may be used to mark a gingiva type or the configuration of the model teeth 170 to match a corresponding dental matrix. The one or more indications 302 may include a shape, a pattern, a design, a letter, a group of letters, a number, and combinations thereof. The one or more indications 302 may be printed and/or embossed on the bridge member 300. In some embodiments, the one or more indications 302 may include a groove and/or an elevation.

FIG. 4E illustrates the second member 140 of the model dental arch 110 (shown in FIGS. 2A and 2B) according to another embodiment of the present disclosure. In some embodiments, the dental model 100 (shown in FIGS. 2A and 2B) further includes a labeling plate 402. In the illustrated embodiment of FIG. 4E, the second member 140 includes a bridge member 400. The labeling plate 402 may be detachably coupled to the bridge member 400. The bridge member 400 may be substantially equivalent to the bridge member 150 shown in FIGS. 4A and 4B. However, the bridge member 400 includes one or more coupling extensions 401 to detachably couple the labeling plate 402 to the bridge member 400. Specifically, in some embodiments, the labeling plate 402 includes an opening 403, and the one or more coupling extensions 401 of the bridge member 400 are snap-fitted into the opening 403 of the labeling plate 402. In some embodiments, the labeling plate 402 may be slidably coupled to the bridge member 400. In some embodiments, the labeling plate 402 may be adhered to the bridge member 400.

In some embodiments, the bridge member 400 further includes one or more third openings 404 to detachably couple the labeling plate 402 to the bridge member 400. In some embodiments, the labeling plate 402 may include one or more protrusions (not shown) that may be snap-fitted into the one or more third openings 404. In the illustrated embodiment of FIG. 4E, the labeling plate 402 further includes one or more indications 406 for identification of the dental model 100 (shown in FIGS. 2A and 2B). In some cases, the dental model 100 may be patient specific. Therefore, the one or more indications 406 may be used to identify the dental model 100 made specifically for a patient. In some cases, the one or more indications 406 may be used to label the different configurations of the dental model 100. The one or more indications 406 may include, for example, a shape, a pattern, a design, a letter, a group of letters, a number, and combinations thereof. The one or more indications 406 may be printed and/or embossed on the labeling plate 402. In some embodiments, the one or more indications 406 may include a groove and/or an elevation. In some embodiments, the one or more indications 406 may be formed with a colored material different from that of the labelling plate 402.

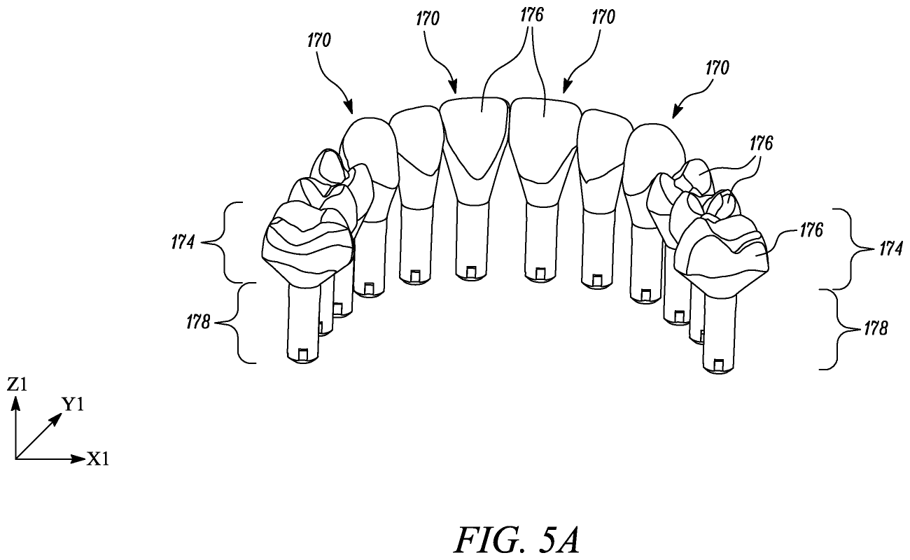

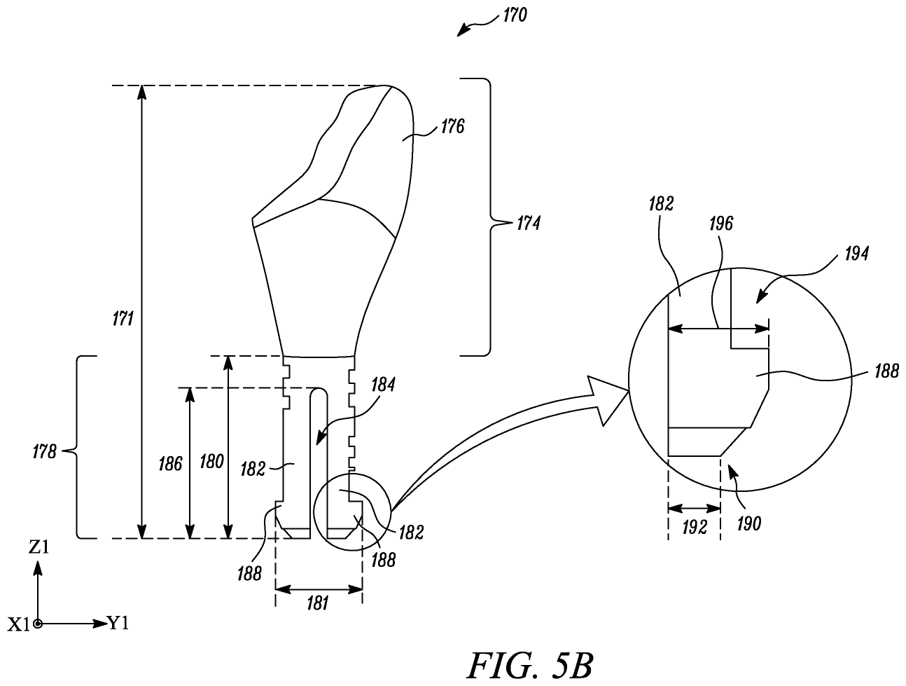

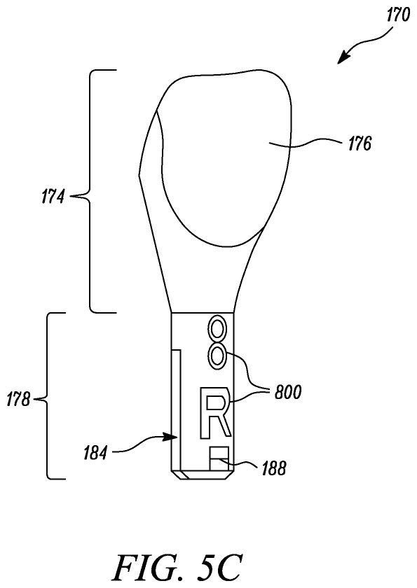

FIG. 5A illustrates a schematic perspective view of the plurality of model teeth 170 according to an embodiment of the present disclosure. FIG. 5B illustrates a schematic side view of the model tooth 170 from the plurality of model teeth 170 according to an embodiment of the present disclosure.

Referring to FIGS. 5A and 5B, each of the plurality of model teeth 170 includes a tooth portion 174 representative of a corresponding human tooth 30 (shown in FIG. 1) from the plurality of human teeth 30 (shown in FIG. 1). The tooth portion 174 of each of the plurality of model teeth 170 includes an outer surface 176. Each of the plurality of model teeth 170 further includes a connecting portion 178 extending from the tooth portion 174. As shown in FIG. 5B, each of the plurality of the model teeth 170 includes a length 171. The length 171 may be defined as a maximum length of a respective model tooth 170. The length 171 may be substantially measured along the Z1-axis.

Further, the connecting portion 178 includes a length 180. The length 180 may be defined as a maximum length of the connecting portion 178 of the respective model tooth 170. The length 180 may be measured substantially along the Z1-axis. In the illustrated embodiment of FIG. 5B, the length 180 of the connecting portion 178 is about 40% of the length 171 of the model tooth 170. However, in some other embodiments, the length 180 of the connecting portion 178 may be at least about 30%, at least about 35%, at least about 45%, at least about 50%, at least about 55%, or at least about 60% of the length 171 of the model tooth 170. The connecting portion 178 of each of the model teeth 170 further includes a maximum width 181. The maximum width 181 may be measured substantially perpendicular to the Z1-axis.

In some embodiments, the connecting portion 178 of each of the plurality of model teeth 170 includes a pair of retention legs 182. The pair of retention legs 182 define a slot 184 therebetween. In some embodiments, the slot 184 may be empty, i.e., filled of air. In some other embodiments, the slot 184 may be filled with a low modulus material. Further, each retention leg 182 includes a length 186. The length 186 may be measured substantially along the Z1-axis. In the illustrated embodiment of FIG. 5B, the length 186 of each retention leg 182 is about 80% of the length 180 of the connecting portion 178. However, in some other embodiments, the length 186 of each retention leg 182 may be greater than about 60%, greater than about 70%, greater than about 85%, greater than about 90%, greater than about 95%, or greater than about 99% of the length 180 of the connecting portion 178.

In some embodiments, each of the pair of retention legs 182 further includes at least one protrusion 188. In some embodiments, the at least one protrusion 188 further includes an entrance end 190 and a retention end 194. The entrance end 190 defines a width 192, and the retention end 194 defines a width 196. The widths 192, 196 may be measured substantially perpendicular to the Z1-axis. In some embodiments, the width 196 of the retention end 194 is greater than the width 192 of the entrance end 190.

In some embodiments, the connecting portion 178 of each of the plurality of model teeth 170 includes one or more grooves (not shown). The one or more grooves may ensure a proper positioning of each model tooth 170 with respect to the first and second members 120, 140 (shown in FIGS. 3A-3C and 4A-4E). Specifically, the one or more grooves may allow each of the plurality of model teeth 170 to at least partially rotate upon being received in the first and second members 120, 140 to ensure the proper positioning of each model tooth 170 in the respective first and second openings 122, 142 (shown in FIGS. 3A-3C and 4A-4E). In some embodiments, the first and second members 120, 140 (shown in FIGS. 3A-3C and 4A-4E) may include one or more protrusions (not shown) corresponding to the one or more grooves to ensure the proper positioning of each model tooth 170 in the respective first and second openings 122, 142 (shown in FIGS. 3A-3C and 4A-4E).

In some embodiments, each of the plurality of model teeth 170 includes a third material having a third elastic modulus. In some embodiments, the third elastic modulus is equal to the second elastic modulus. In some cases, the second member 140 (shown in FIGS. 4A-4C) and each of the plurality of model teeth 170 may be made from a same material. However, in some other cases, the second member 140 and each of the plurality of model teeth 170 may be made from different materials having a same elastic modulus. In some embodiments, the second material of the second member 140 and the third material of the plurality of model teeth 170 may include a high modulus photopolymer. The third material may allow drilling cavities in the plurality of model teeth 170.

In some embodiments, each of the first material, the second material, and the third material of the first member 120 (shown in FIGS. 3A-3C), the second member 140, and the plurality of model teeth 170, respectively, may include organic resins with various functionality such as acrylic resins, silicone resins, urethane resins, and epoxy resins with different elastic moduli. In some embodiments, the first, second, and third material may include poly(methyl methacrylate) (PMMA) mixed with methyl methacrylate. Each of the first material, the second material, and the third material may be available in powdered and liquid form. The resins may be filled with organic, inorganic, and/or composite fillers.

FIG. 5C illustrates the model tooth 170 from the plurality of model teeth 170 according to another embodiment of the present disclosure. In the illustrated embodiment of FIG. 5C, the connecting portion 178 includes one or more indications 800 for identification of the model tooth 170. In some embodiments, each of the plurality of model teeth 170 may include the one or more indications 800. As discussed above, the plurality of model teeth 170 may represent the plurality of human teeth 30 (shown in FIG. 1), and therefore may be patient specific. Therefore, the one or more indications 800 may be used to identify the plurality of model teeth 170 made specifically for a patient. In some embodiments, the one or more indications 800 may be used to identify the plurality of model teeth 170 configured to be at least partially and slidably received in the respective first and second openings 122, 142 (shown in FIGS. 3A-3C and 4A-4E). In some embodiments, the one or more indications 800 may be used to identify a suitable dental matrix for a configuration of the model tooth 170. The one or more indications 800 may include a shape, a pattern, a design, a letter, a group of letters, a number, and combinations thereof. The one or more indications 800 may be printed and/or embossed on the connecting portion 178 of the model tooth 170. In some embodiments, the one or more indications 800 may include a groove and/or an elevation.

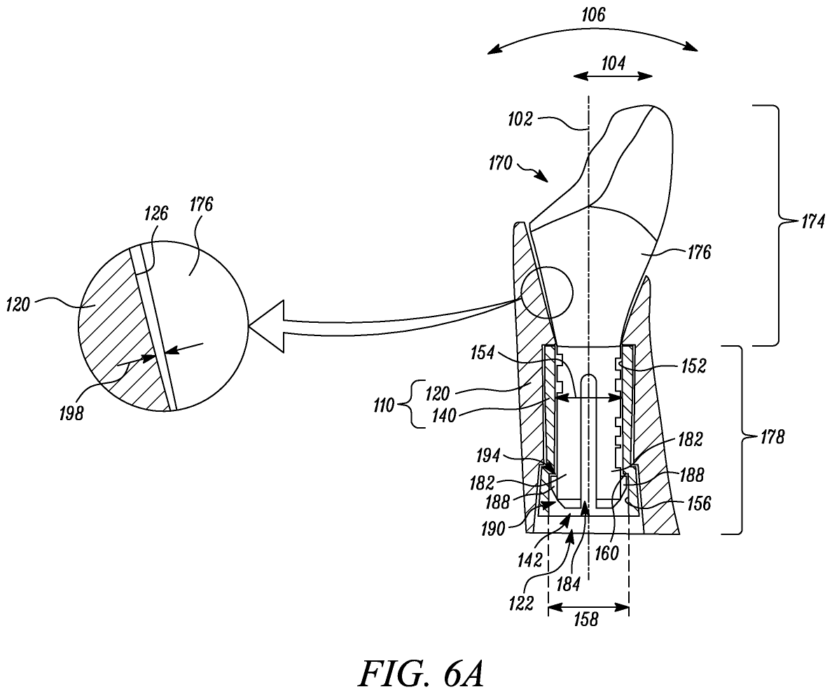

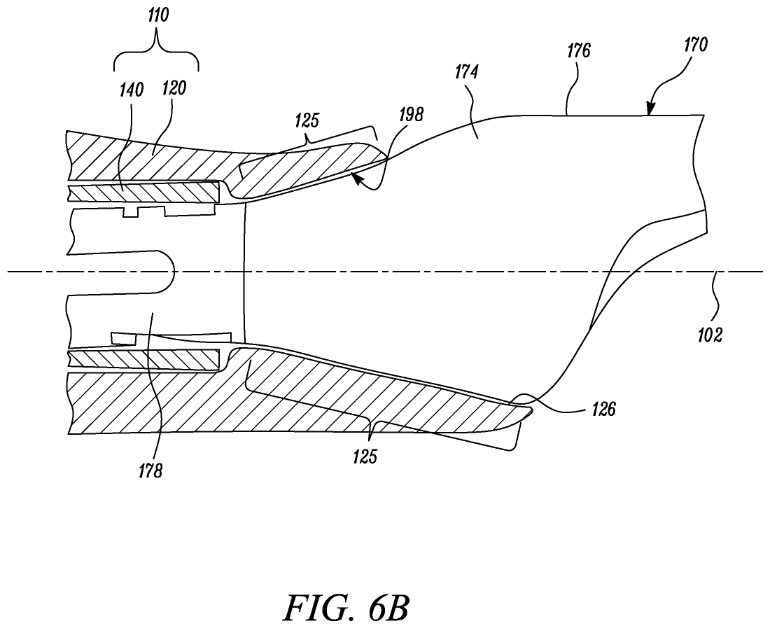

FIGS. 6A and 6B illustrate schematic cross-sectional views of the model tooth 170 received in the first and second openings 122, 142 of the first and second members 120, 140, respectively. In some embodiments, the tooth portion 174 of each of the plurality of model teeth 170 is at least partially and slidably received in the respective first opening 122 from the plurality of first openings 122. Furthermore, the connecting portion 178 of each of the plurality of model teeth 170 is at least partially received in the respective second opening 142 from the plurality of second openings 142 and detachably retained in the respective second opening 142. In some embodiments, a shape of the surface 126 of the first member 120 forming the respective first opening 122 is at least partially similar to a shape of the outer surface 176 of the tooth portion 174.

As discussed above, in some embodiments, the pair of retention legs 182 define the slot 184 therebetween. Specifically, in some embodiments, the pair of retention legs 182 define the slot 184 therebetween, such that the pair of retention legs 182 resiliently move towards each other upon insertion of the pair of retention legs 182 into the first portion 152 of the respective second opening 142. In other words, the pair of retention legs 182 may resiliently flex towards each other upon insertion of the connecting portion 178 into the first portion 152 of the respective second opening 142. The pair of retention legs 182 may resiliently move towards each other until the at least one protrusion 188 is received in the second portion 156 of the respective second opening 142.

As discussed above, in some embodiments, the pair of retention legs 182 further includes the at least one protrusion 188. Specifically, in some embodiments, the pair of retention legs 182 further includes the at least one protrusion 188, such that the at least one protrusion 188 engages the retaining surface 160 of the respective second opening 142. Specifically, the at least one protrusion 188 includes the entrance end 190 configured to be received within the second portion 156 of the respective second opening 142, and the retention end 194 configured to engage with the retaining surface 160. Further, the pair of retention legs 182 may at least partially flex back such that the at least one protrusion 188 is retained in the second portion 156 of the respective second opening 142 by the engagement between the retaining surface 160 and the retention end 194.

In some embodiments, to detach the plurality of model teeth 170 from the model dental arch 110, the pair of retention legs 182 may be resiliently moved towards each other, such that the retention end 194 of the at least one protrusion 188 may pass through the first portion 152 of the respective second opening 142. In some embodiments, a suitable tool (not shown) may be used to detach the plurality of model teeth 170 from the model dental arch 110.

Therefore, the dental model 100 may reduce a time consumed in assembling and disassembling the dental model 100. In other words, each of the plurality of model teeth 170 may be quickly removed from the model dental arch 110 when desired. For example, each of the plurality of model teeth 170 may be snap-fitted in the first and second members 120, 140 of the model dental arch 110 to facilitate quick attachment and removal of the plurality of model teeth 170.

In some embodiments, the maximum width 181 (shown in FIG. 5B) of the connecting portion 178 of each of the plurality of model teeth 170 is at least about 95% of the first width 154 of the first portion 152 of the respective second opening 142. In some embodiments, the maximum width 181 of the connecting portion 178 of each of the plurality of model teeth 170 is at least about 96%, or at least about 98% of the first width 154 of the first portion 152 of the respective second opening 142. In such embodiments, an amount of deflection of the connecting portion 178 during snap-fit engagement and disengagement of the model tooth 170 from the dental model 100 may be small.

In some other embodiments, the maximum width 181 (shown in FIG. 5B) of the connecting portion 178 of each of the plurality of model teeth 170 is at most about 75% of the first width 154 of the first portion 152 of the respective second opening 142. In some embodiments, the maximum width 181 of the connecting portion 178 of each of the plurality of model teeth 170 is at most about 50%, at most about 60%, or at most about 70% of the first width 154 of the first portion 152 of the respective second opening 142. In such embodiments, the amount of deflection of the connecting portion 178 during engagement and disengagement of the model tooth 170 from the dental model 100 may be relatively large.

Referring to FIGS. 6A and 6B, in some cases, the tooth portion 174 of each of the plurality of model teeth 170 and at least a portion 125 of the surface 126 of the first member 120 forming the respective first opening 122 define a clearance 198 therebetween, such that upon application of a lateral load on each of the plurality of model teeth 170 in a direction 104 substantially perpendicular to the longitudinal axis 102, each of the plurality of model teeth 170 flexes laterally from at least about 50 microns to at most about 250 microns in the direction 104 substantially perpendicular to the longitudinal axis 102. In some embodiments, the clearance 198 is at least about 50 microns. In some other embodiments, the clearance 198 may be at least about 55 microns, at least about 60 microns, at least about 65 microns, or at least about 70 microns.

In some embodiments, the dental model 100 (shown in FIGS. 2A and 2B) further includes a low modulus material (not shown) at least partially filling the clearance 198. In some embodiments, the low modulus material may include elastomeric silicones. The low modulus material has an elastic modulus of at most about 20% of the second elastic modulus. In some embodiments, the elastic modulus of the low modulus material may be at most about 15%, at most about 10%, or at most about 5% of the second elastic material.

In some other cases, the first elastic modulus of the first material is from about 0.1 MPa to about 5 MPa, such that upon application of the lateral load on each of the plurality of model teeth 170 in the direction 104 substantially perpendicular to the longitudinal axis 102, each of the plurality of model teeth 170 flexes laterally from at least about 50 microns to at most about 250 microns in the direction 104 substantially perpendicular to the longitudinal axis 102. That is, in some embodiments, the first elastic modulus of the first material may be less than each of the second elastic modulus of the second material of the second member 140 and the third elastic modulus of the third material of the plurality of model teeth 170.

In some other cases, the tooth portion 174 of each of the plurality of model teeth 170 and at least the portion 125 of the surface 126 of the first member 120 forming the respective first opening 122 define the clearance 198 therebetween and the first elastic modulus of the first material is from about 0.1 MPa to about 5 MPa, such that upon application of the lateral load on each of the plurality of model teeth 170 in the direction 104 substantially perpendicular to the longitudinal axis 102, each of the plurality of model teeth 170 flexes laterally from at least about 50 microns to at most about 250 microns in the direction 104 substantially perpendicular to the longitudinal axis 102.

In other words, each of the plurality of the model tooth 170 in the respective first and second openings 122, 142 provides a lateral flexure 106 from at least about 50 microns to at most about 250 microns in the direction 104 substantially perpendicular to the longitudinal axis 102. Thus, the lateral flexure 106 may be engineered to simulate movement of the human teeth 30 (shown in FIG. 1) in the human dental arch 10 (shown in FIG. 1).

In some embodiments, a mobility of each of the plurality of model teeth 170 with respect to the model dental arch 110 (shown in FIGS. 2A and 2B) may be low. Such embodiments may be used to simulate a case of tooth ankylosis, in which the model teeth 170 may be configured to have a low mobility, similar to the human teeth 30 of the human dental arch 10 having the case of tooth ankylosis.

In some other embodiments, the mobility of each of the plurality of model teeth 170 may be relatively high. Such embodiments may be used to simulate a case of periodontitis, in which the model teeth 170 may be configured to have a high mobility, similar to the human teeth 30 of the human dental arch 10 having the case of periodontitis.

Therefore, the dental model 100 may provide a realistic simulation of the human dental arch 10 for the in-vivo procedure. Specifically, the dental model 100 may simulate realistic movements of the plurality of human teeth 30.

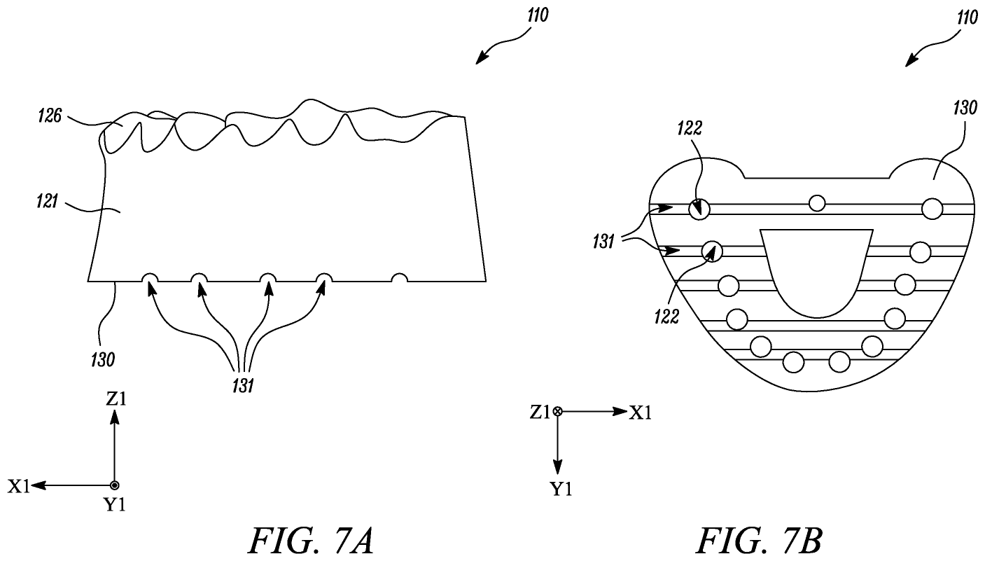

FIGS. 7A and 7B illustrate a schematic side view and a schematic bottom view, respectively, of the model dental arch 110. As discussed above, in some embodiments, the model dental arch 110 includes the bottom surface 130. Specifically, in some embodiments, the model dental arch 110 includes the bottom surface 130 distal to the tooth portion 174 (shown in FIGS. 5A and 5B) of each of the plurality of model teeth 170. In some embodiments, the bottom surface 130 defines a plurality of channels 131.

Further, in the illustrated embodiment of FIGS. 7A and 7B, each of the plurality of channels 131 passes through at least one of the plurality of first openings 122. In some cases, each of the plurality of channels 131 may be equidistant from each other. In some embodiments, the model dental arch 110 may be additively manufactured starting from the bottom surface 130 to the surface 126. In some embodiments, the model dental arch 110 may be additively manufactured in an inverted style. In some embodiments, the plurality of channels 131 may allow venting during additive manufacturing process of the model dental arch 110. Specifically, the plurality of channels 131 may prevent the plurality of first openings 122 from collapsing in due to a suction pressure generated during the additive manufacturing process. Therefore, the plurality of channels 131 may improve an efficiency of the additive manufacturing process and may prevent manufacturing defects.

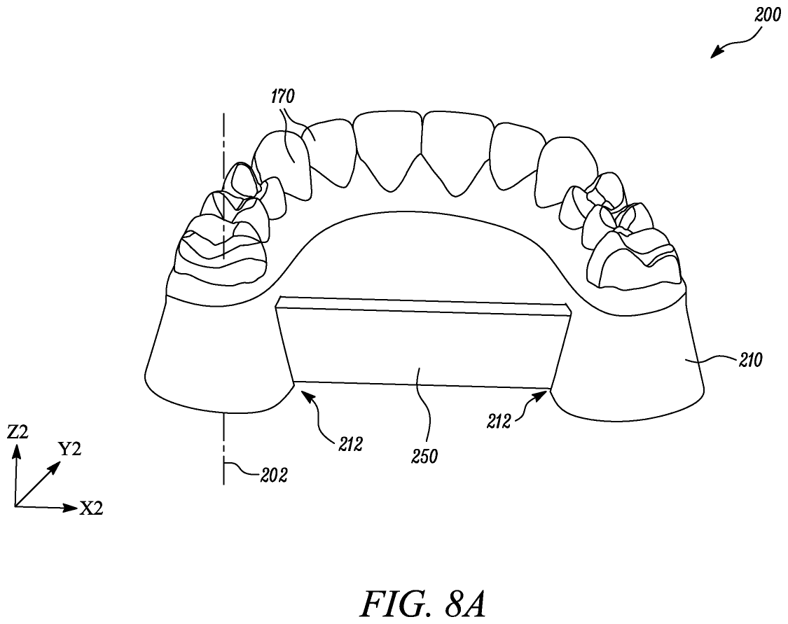

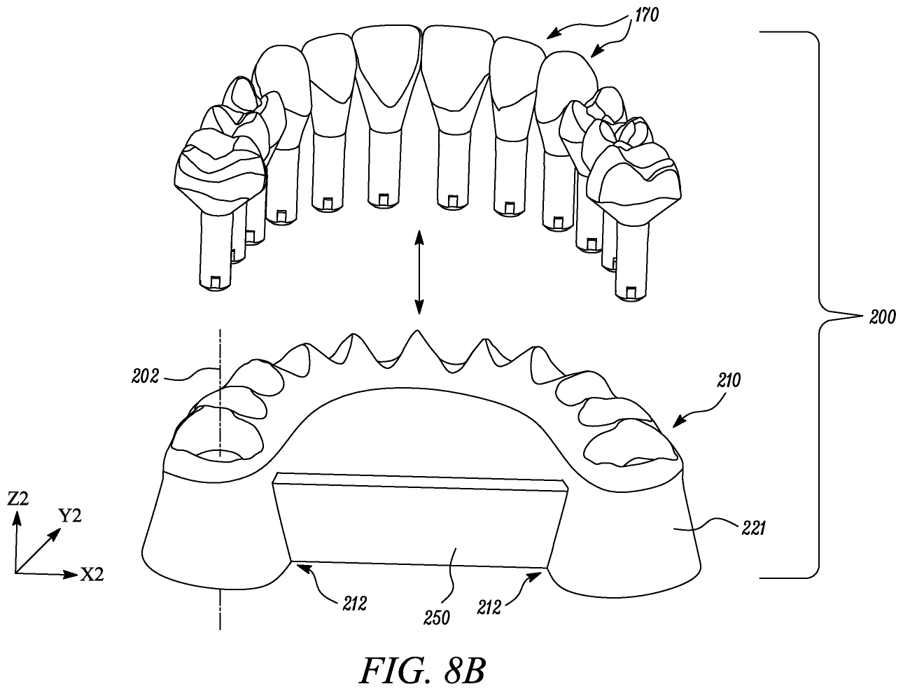

FIGS. 8A and 8B illustrate a dental model 200 according to another embodiment of the present disclosure. The dental model 200 defines mutually orthogonal X2, Y2, and Z2-axes. The X2 and Y2-axes are in-plane axes of the dental model 200, while the Z2-axis is a transverse axis disposed along a thickness of the dental model 200. In other words, the X2 and Y2-axes are disposed along a plane of the dental model 200, while the Z2-axis is perpendicular to the plane of the dental model 200.

Referring to FIGS. 8A and 8B, the dental model 200 includes a model dental arch 210. The model dental arch 210 is representative of the human dental arch 10 (shown in FIG. 1) of the patient. In some embodiments, the model dental arch 210 may have an arch-shape corresponding to the portion of the human dental arch 10 represented by the dental model 200. The dental model 200 further includes the plurality of model teeth 170 corresponding to the plurality of human teeth 30 (shown in FIG. 1). The dental model 200 may provide important information about the one or more human teeth 30 of the patient to aid in planning a dental treatment, such as an oral surgery, a dental restoration, and the like. The dental model 200 may be fabricated using a suitable process, depending upon desired application attributes. In some embodiments, the dental model 200 is patient specific and additively formed. In some other embodiments, the dental model 200 may fabricated all or in part using injection molding. That is, in some embodiments, the dental model 200 is injection molded.

In the illustrated embodiment of FIGS. 8A and 8B, the dental model 200 further includes a bridge member 250 connected to two or more spaced apart locations 212 on the model dental arch 210. The bridge member 250 may be connected to the two or more spaced apart locations 212 on the model dental arch 110 to provide improved stability and rigidity to the model dental arch 210.

In the illustrated embodiment of FIG. 8B, the model dental arch 210 has a single part configuration in contrast to the two part configuration of the model dental arch 110 shown in FIG. 2B.

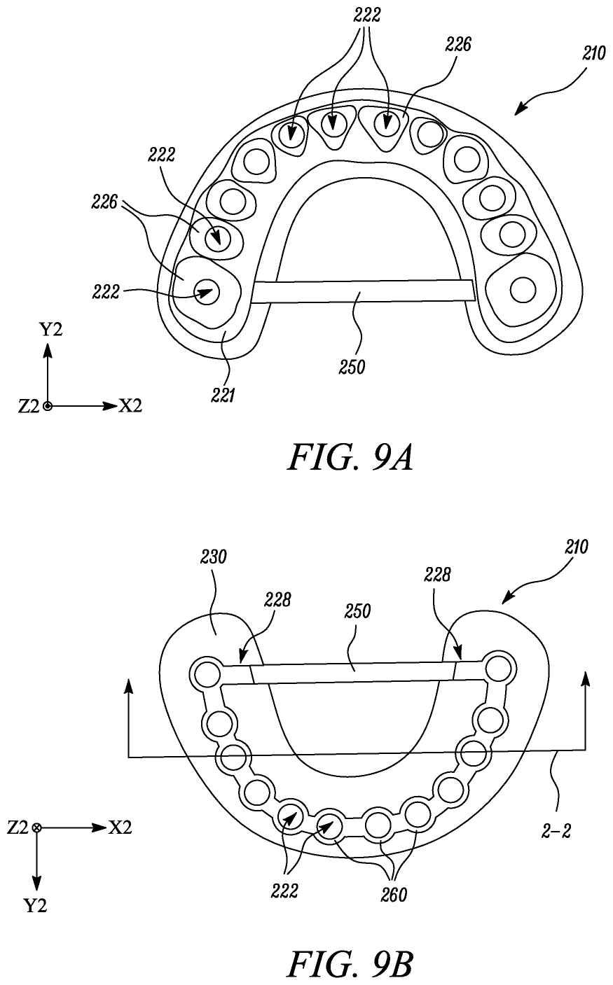

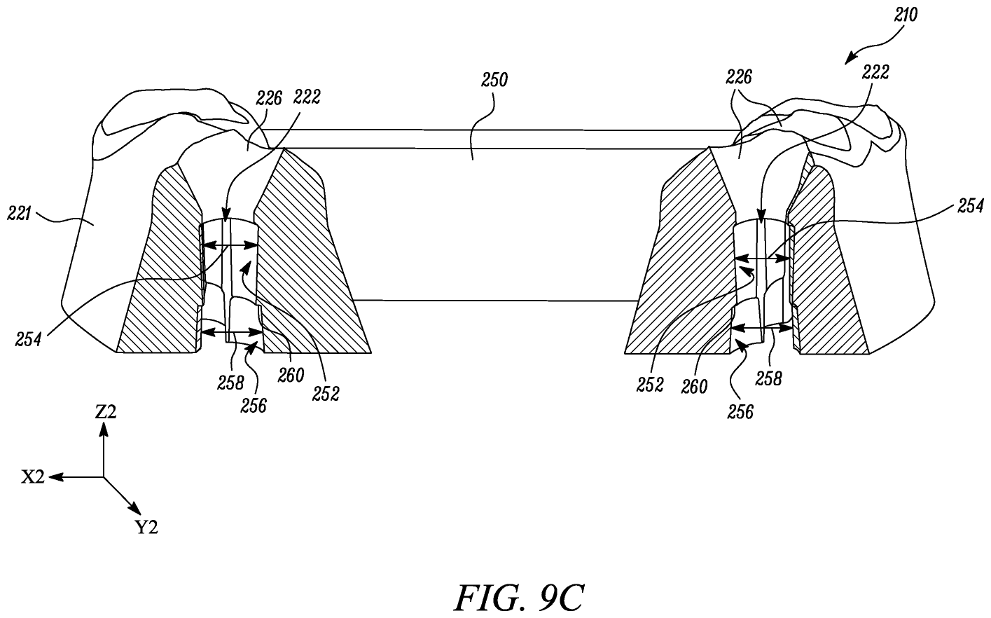

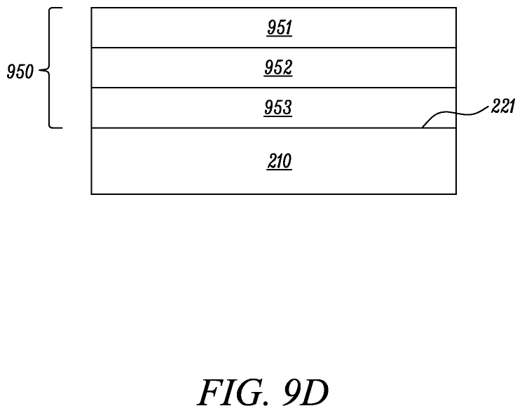

FIGS. 9A and 9B illustrate the model dental arch 210 according to an embodiment of the present disclosure. Specifically, FIGS. 9A and 9B illustrate a top view and a bottom view, respectively, of the model dental arch 210. FIG. 9C illustrates a schematic cross-sectional view of the model dental arch 210, taken generally along line 2-2 of FIG. 9B. The model dental arch 210 includes an outer surface 221. The model dental arch 210 includes a plurality of openings 222 therethrough. Each of the plurality of openings 222 extends along a longitudinal axis 202 (shown in FIGS. 8A and 8B). In some embodiments, each of the plurality of openings 222 may extend substantially along the Z2-axis. In other words, the longitudinal axis 202 may be substantially parallel to the Z2-axis. In the illustrated embodiment of FIGS. 9A and 9B, at least a portion of each of the plurality of openings 222 has a substantially circular shape. However, each of the plurality of openings 222 may have any suitable shape, such as a semicircular shape, a triangular shape, a rectangular shape, a square shape, a polygonal shape, an elliptical shape, an oval shape, a shape based on natural tooth structure, an irregular shape, and so forth. As shown in FIGS. 9B and 9C, in some embodiments, the model dental arch 210 further includes a plurality of retaining surfaces 260 corresponding to the plurality of openings 222.

Referring to FIGS. 9A and 9B, the model dental arch 210 further includes a plurality of surfaces 226 corresponding to the plurality of openings 222. Each surface 226 from the plurality of surfaces 226 forms a respective opening 222 from the plurality of openings 222. In other words, each opening 222 is defined by a corresponding surface 226. In some embodiments, the outer surface 221 of the model dental arch 210 includes the plurality of surfaces 226.

Further, the model dental arch 210 further includes a bottom surface 230. In some embodiments, the bottom surface 230 of the model dental arch 210 may be substantially parallel to a plane perpendicular to the Z2-axis. In other words, the bottom surface 230 of the model dental arch 210 may be substantially disposed in the X2-Y2-plane.

In the illustrated embodiment of FIG. 9B, the model dental arch 210 further defines a plurality of coupling channels 228. In some embodiments, each of the plurality of coupling channels 228 is configured to at least partially receive the bridge member 250 therein. In some embodiments, the bridge member 250 and the model dental arch 210 may be formed as a single integral part. However, in some other embodiments, the model dental arch 210 and the bridge member 250 may formed as two separate parts coupled to each other using at least one of a snap-in fit, a slidable coupling, a bolt, an adhesive, and the like. In other words, the model dental arch 210 and the bridge member 250 may be snap-fitted, slidably coupled to each other, bolted together, or bonded together. In some embodiments, the bridge member 250 has an elongate rectangular shape. However, in some other embodiments, the bridge member 250 may include any suitable shape, as per desired application attributes. In some embodiments, the bridge member 250 may extend substantially along the X2-axis.

The model dental arch 210 further includes a material having an elastic modulus. In some embodiments, the elastic modulus of the material is from about 0.1 MPa to about 5 MPa. In some embodiments, the elastic modulus of the material may be less than about 5 MPa, and greater than 0.1 MPa, greater than 0.2 MPa, greater than 0.3 MPa, or greater than 0.4 MPa. In some embodiments, the elastic modulus of the material may be less than 5 MPa, less than 4 MPa, less than 3 MPa, or less than 2 MPa. In some other embodiments, the elastic modulus of the material is from about 750 MPa to about 20000 MPa. In some embodiments, the elastic modulus of the material may be greater than 300 MPa, greater than 500 MPa, greater than 750 MPa, greater than 1000 MPa, or greater than 1250 MPa. In some embodiments, the elastic modulus of the material may be greater than about 300 MPa, and less than 20000 MPa, less than 18000 MPa, less than 16000 MPa, or less than 14000 MPa. In some embodiments, the elastic modulus of the material may be from about 1000 MPa to about 16000 MPa.

In the illustrated embodiment of FIG. 9C, each of the plurality of openings 222 includes a first portion 252 having a first width 254 and a second portion 256 disposed adjacent to the first portion 252 and having a second width 258. In some embodiments, the second width 258 of the second portion 256 is greater than the first width 254 of the first portion 252. Further, in some embodiments, each retaining surface 260 extends between the first portion 252 and the second portion 256 of the corresponding opening 222.

FIG. 9D illustrates a schematic block diagram showing one or more coatings 950 disposed on the model dental arch 210. In some embodiments, the dental model 200 (shown in FIGS. 8A and 8B) further includes the one or more coatings 950 disposed at least partly on the outer surface 221 of the model dental arch 210. In the illustrated embodiment of FIG. 9D, the one or more coatings 950 includes a first coating 951, a second coating 952 and a third coating 953. The first, second and third coatings 901, 902, 903 may be similar to or different from each other. The one or more coatings 950 may include, for example, resins. The one or more coatings 950 may also include inorganic layers. In some embodiments, the one or more coatings 950 may be applied on the model dental arch 210 to facilitate removing cured composite excess from the model dental arch 210 to simulate the in-vivo procedure. Further, the one or more coatings 950 may prevent the cured composite excess from bonding to the dental model 200 when curing. Therefore, the one or more coatings 950 may facilitate preparation of the model dental arch 210 for reuse. Thus, the dental model 200 may be reusable, and simulate the in-vivo procedure. In some embodiments, the one or more coatings 950 may be disposed at least partly on the outer surface 221 of the model dental arch 210 to improve surface properties of the outer surface 221 (e.g., reduction in surface roughness, and reduction in flaking). In some embodiments, the one or more coatings 900 may allow removal of a dental restorative material that may be cured on the outer surface 221 of the model dental arch 210 further simulating the dental treatment.

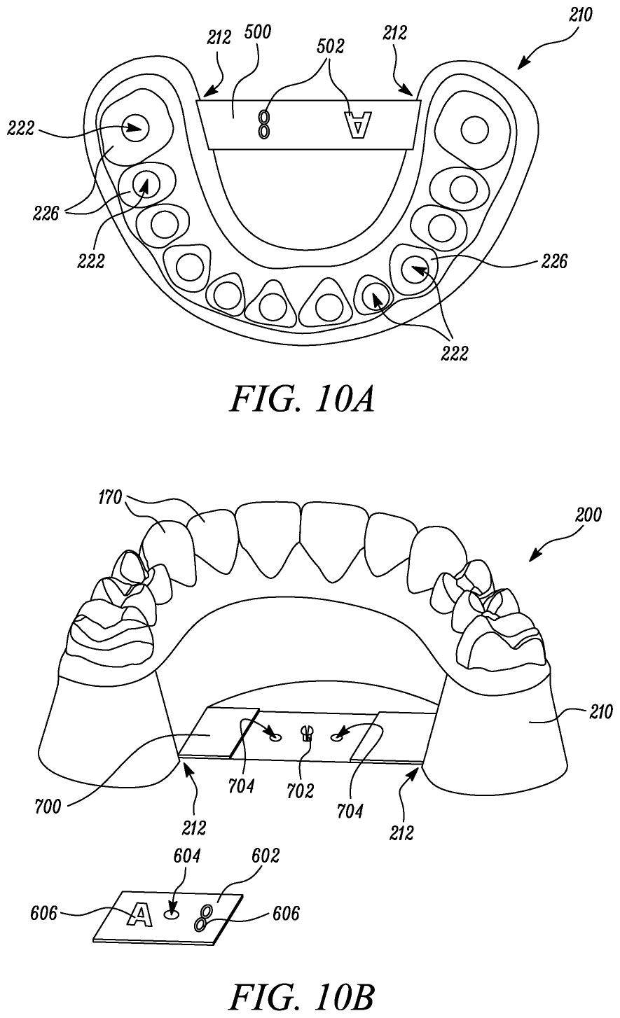

FIG. 10A illustrates the model dental arch 210 according to an embodiment of the present disclosure. In the illustrated embodiment of FIG. 10A, the model dental arch 210 includes a bridge member 500. The bridge member 500 may be substantially equivalent to the bridge member 250 shown in FIGS. 8A and 8B. However, the bridge member 500 further includes one or more indications 502 for identification of the dental model 200 (shown in FIG. 8A). In some cases, the dental model 200 may be patient specific. Therefore, the one or more indications 502 may be used to identify the dental model 200 made specifically for a patient. In some embodiments, the one or more indications 502 may be used to indicate a configuration of the model teeth 170 (shown in FIGS. 2A and 2B) for non-custom, or off-the-shelf dental models. In some embodiments, the one or more indications 502 may be used to mark a gingiva type or the configuration of the model teeth 170 to match a corresponding dental matrix. The one or more indications 502 may include a shape, a pattern, a design, a letter, a group of letters, a number, and combinations thereof. The one or more indications 502 may be printed, and/or embossed on the bridge member 500. In some embodiments, the one or more indications 502 may include a groove and/or an elevation.

FIG. 10B illustrates the dental model 200 according to an embodiment of the present disclosure. In some embodiments, the dental model 200 further includes a labeling plate 602. In the illustrated embodiment of FIG. 10B, the model dental arch 210 includes a bridge member 700. The labeling plate 602 may be detachably coupled to the bridge member 700. The bridge member 700 may be substantially equivalent to the bridge member 250 shown in FIGS. 8A and 8B. However, the bridge member 700 includes one or more openings 704 to detachably couple the labeling plate 602 to the bridge member 700. In some embodiments, the labeling plate 602 may further include one or more protrusions (not shown) that may be snap-fitted into the one or more openings 704. In some embodiments, the labeling plate 602 may be slidably coupled to the bridge member 700. In some embodiments, the labeling plate 602 may be adhered to the bridge member 700.

In some embodiments, the labeling plate 602 further includes one or more indications 606 for identification of the dental model 200. As discussed above, the dental model 200 may be patient specific. The one or more indications 606 may be used to identify the dental model 200 made specifically for a patient. The one or more indications 606 may include a shape, a pattern, a design, a letter, a group of letters, a number, and combinations thereof. The one or more indications 606 may be printed and/or embossed on the labeling plate 602. In some embodiments, the one or more indications 606 may include a groove and/or an elevation. In some embodiments, the one or more indications 606 may be formed with a colored material different from that of the labelling plate 602.

In the illustrated embodiment of FIG. 10B, the dental model 200 further includes one or more coupling extensions 702 to detachably couple the labeling plate 602 to the bridge member 700. Specifically, in some embodiments, the labeling plate 602 includes an opening 604, and the one or more coupling extensions 702 of the bridge member 700 are snap-fitted into the opening 604 of the labeling plate 602.

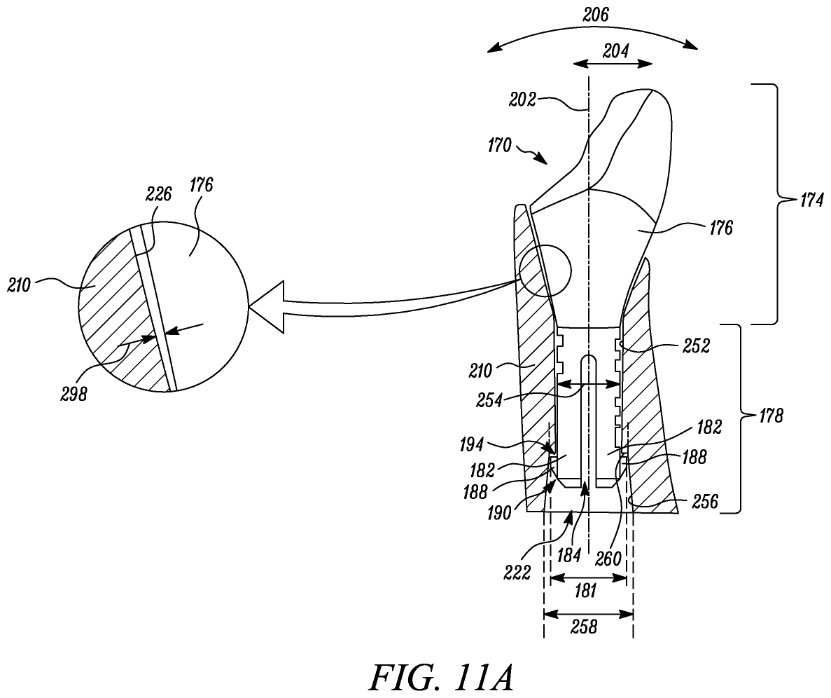

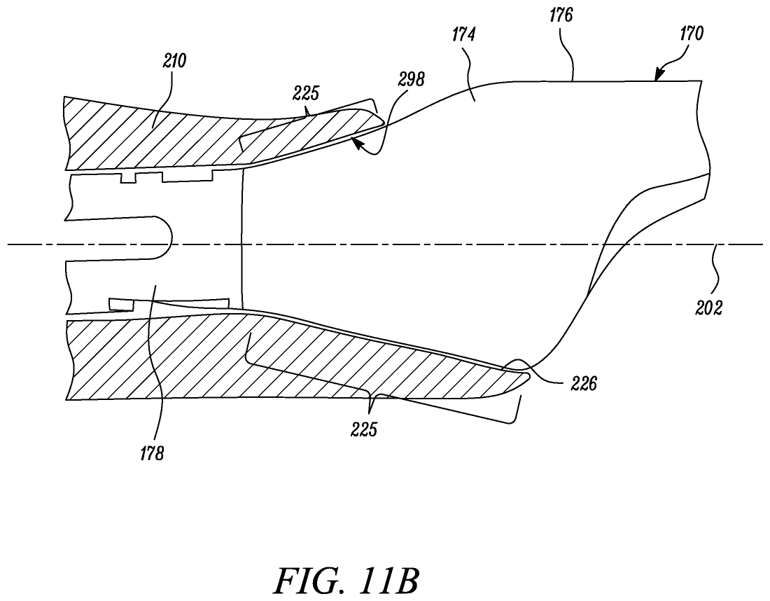

FIGS. 11A and 11B illustrate schematic cross-sectional views of the model tooth 170 received in the opening 222. The tooth portion 174 and the connecting portion 178 of each of the plurality of model teeth 170 is at least partially and slidably received in the respective opening 222 from the plurality of openings 222. In some embodiments, a shape of the surface 226 (shown in FIGS. 9A, 9B, and 9C) of the model dental arch 210 forming the respective opening 222 is at least partially similar to the shape of the outer surface 176 of the tooth portion 174.

The connecting portion 178 of each of the plurality of model teeth 170 is detachably retained in the respective opening 222. Further, the pair of retention legs 182 of the model tooth 170 define the slot 184 therebetween, such that the pair of retention legs 182 resiliently move towards each other upon insertion of the pair of retention legs 182 into the first portion 252 of the respective opening 222. In other words, the pair of retention legs 182 may resiliently flex towards each other upon insertion of the pair of retention legs 182 into the first portion 252 of the respective opening 222. Each of the pair of retention legs 182 further includes the at least one protrusion 188, such that the at least one protrusion 188 engages the retaining surface 260 of the respective opening 222. Specifically, the at least one protrusion 188 includes the entrance end 190 configured to be received within the second portion 256 of the respective opening 222, and the retention end 194 configured to engage with the retaining surface 260. Further, the pair of retention legs 182 may at least partially flex back such that the at least one protrusion 188 is retained in the respective opening 222 by the retaining surface 260 and the retention end 194. In some embodiments, to detach the plurality of model teeth 170 from the model dental arch 210, the pair of retention legs 182 may be resiliently moved towards each other, such that the retention end 194 of the at least one protrusion 188 may pass through the first portion 252 of the respective opening 222. In some embodiments, a suitable tool (not shown) may be used to detach the plurality of model teeth 170 from the model dental arch 210. Therefore, the dental model 200 may reduce a time consumed in assembling and disassembling the dental model 200. In other words, each of the plurality of model teeth 170 may be quickly removed from the model dental arch 210 when desired. For example, each of the plurality of model teeth 170 may be snap-fitted in the model dental arch 210 to facilitate quick attachment and removal of the plurality of model teeth 170.

In some embodiments, the maximum width 181 of the connecting portion 178 of each of the plurality of model teeth 170 is at least about 95% of the first width 254 of the first portion 252 of the respective opening 222. In some embodiments, the maximum width 181 of the connecting portion 178 of each of the plurality of model teeth 170 is at least about 96%, or at least about 98% of the first width 154 of the first portion 152 of the respective second opening 142. In such embodiments, an amount of deflection of the connecting portion 178 during snap-fit engagement and disengagement of the model tooth 170 from the dental model 100 may be small.

In some other embodiments, the maximum width 181 of the connecting portion 178 of each of the plurality of model teeth 170 is at most about 75% of the first width 254 of the first portion 252 of the respective opening 222. In some embodiments, the maximum width 181 of the connecting portion 178 of each of the plurality of model teeth 170 is at most about 50%, at most about 60%, or at most about 70% of the first width 154 of the first portion 152 of the respective second opening 142. In such embodiments, the amount of deflection of the connecting portion 178 during snap-fit engagement and disengagement of the model tooth 170 from the dental model 100 may be relatively large.

Referring to FIGS. 11A and 11B, in some cases, the tooth portion 174 of each of the plurality of model teeth 170 and at least a portion 225 of the surface 226 of the model dental arch 210 forming the respective opening 222 define a clearance 298 therebetween, such that upon application of a lateral load on each of the plurality of model teeth 170 in a direction 204 substantially perpendicular to the longitudinal axis 202, each of the plurality of model teeth 170 flexes laterally from at least about 50 microns to at most about 250 microns in the direction 204 substantially perpendicular to the longitudinal axis 202. In some embodiments, the clearance 298 is at least about 50 microns. In some other embodiments, the clearance 298 may be at least about 55 microns, at least about 60 microns, at least about 65 microns, or at least about 70 microns.

In some embodiments, the dental model 200 (shown in FIGS. 8A and 8B) further includes a low modulus material (not shown) at least partially filling the clearance 298. In some embodiments, the low modulus material may include elastomeric silicones. The low modulus material has an elastic modulus less than the elastic modulus of the material of the model dental arch 210. In some embodiments, the elastic modulus of the low modulus material may be at most about 50%, at most about 40%, at most about 30%, at most about 20%, at most about 15%, at most about 10%, or at most about 5% of the elastic material of the material of the model dental arch 210.

In some other cases, the tooth portion 174 of each of the plurality of model teeth 170 and at least the portion 225 of the surface 226 of the model dental arch 210 forming the respective opening 222 define the clearance 298 therebetween and the elastic modulus of the material is from about 750 MPa to about 20000 MPa, such that upon application of the lateral load on each of the plurality of model teeth 170 in the direction 204 substantially perpendicular to the longitudinal axis 202, each of the plurality of model teeth 170 flexes laterally from at least about 50 microns to at most about 250 microns in the direction 204 substantially perpendicular to the longitudinal axis 202.

In some other cases, the elastic modulus of the material of the model dental arch 210 is from about 0.1 MPa to about 5 MPa, such that upon application of the lateral load on each of the plurality of model teeth 170 in the direction 204 substantially perpendicular to the longitudinal axis 202, each of the plurality of model teeth 170 flexes laterally from at least about 50 microns to at most about 250 microns in the direction 204 substantially perpendicular to the longitudinal axis 202.

In some other cases, the tooth portion 174 of each of the plurality of model teeth 170 and at least the portion 225 of the surface 226 of the model dental arch 210 forming the respective opening 222 define the clearance 298 therebetween and the elastic modulus of the material of the model dental arch 210 is from about 0.1 MPa to about 5 MPa, such that upon application of the lateral load on each of the plurality of model teeth 170 in the direction 204 substantially perpendicular to the longitudinal axis 202, each of the plurality of model teeth 170 flexes laterally from at least about 50 microns to at most about 250 microns in the direction 204 substantially perpendicular to the longitudinal axis 202.

In other words, each of the plurality of the model tooth 170 in the respective opening 222 provides a lateral flexure 206 from at least about 50 microns to at most about 250 microns in the direction 204 substantially perpendicular to the longitudinal axis 202. Thus, the lateral flexure 206 may be engineered to simulate movement of the human teeth 30 (shown in FIG. 1) in the human dental arch 10 (shown in FIG. 1).

In some embodiments, a mobility of each of the plurality of model teeth 170 with respect to the model dental arch 210 may be low. Such embodiments may be used to simulate a case of tooth ankylosis, in which the model teeth 170 from the plurality of model teeth 170 may be configured to have a low mobility, similar to the human teeth 30 of the human dental arch 10 (shown in FIG. 1) having the case of tooth ankylosis.

In some other embodiments, the mobility of each of the plurality of model teeth 170 may be relatively high. Such embodiments may be used to simulate a case of periodontitis, in which the model teeth 170 from the plurality of model teeth 170 may be configured to have a high mobility, similar to the human teeth 30 of the human dental arch 10 having the case of periodontitis.

Therefore, the dental model 200 may provide a realistic simulation of the human dental arch 10 for the in-vivo procedure. Specifically, the dental model 200 may simulate realistic movements of the plurality of human teeth 30.

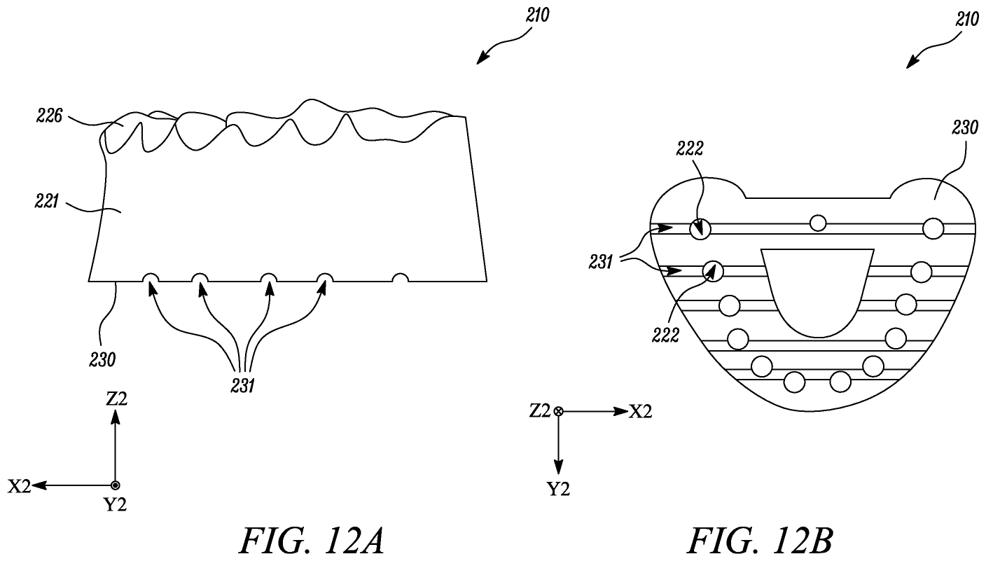

FIGS. 12A and 12B illustrate a schematic side view and a schematic bottom view, respectively, of the model dental arch 210. The model dental arch 210 includes the bottom surface 230 distal to the tooth portion 174 (shown in FIGS. 5A and 5B) of each of the plurality of model teeth 170. In some embodiments, the bottom surface 230 defines a plurality of channels 231.

In the illustrated embodiment of FIGS. 12A and 12B, each of the plurality of channels 231 passes through at least one of the plurality of openings 222. In some cases, each of the plurality of channels 231 may be equidistant from each other. In some embodiments, the dental model 200 may be additively manufactured starting from the bottom surface 230 to the surface 226. In some embodiments, the dental model 200 may be additively manufactured in an inverted style. In some embodiments, the plurality of channels 231 may allow venting during an additive manufacturing process of the dental model 200. Specifically, the plurality of channels 231 may prevent the plurality of openings 222 from collapsing in due to a suction pressure generated during the additive manufacturing process. Therefore, the plurality of channels 231 may improve an efficiency of the additive manufacturing process and may prevent manufacturing defects.

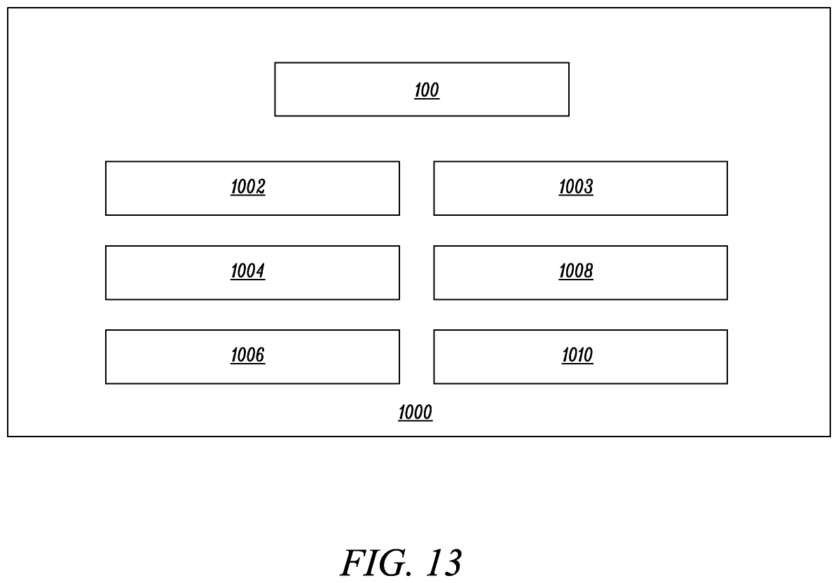

FIG. 13 illustrates a schematic block diagram of a dental kit 1000 (hereinafter, “the kit 1000”) for practicing composite dental restoration according to an embodiment of the present disclosure. In some embodiments, the kit 1000 may be used for practicing direct dental restoration. The kit 1000 includes the dental model 100 (shown in FIGS. 2A and 2B) and one or more dental matrices 1002. However, in some other embodiments, the kit 1000 may include the dental model 200 (shown in FIGS. 8A and 8B) and the one or more dental matrices 1002.

In some embodiments, the one or more dental matrices 1002 is patient specific and additively formed. In some embodiments, at least one of the dental model 100 and the one or more dental matrices 1002 is injection molded. In some embodiments, the kit 1000 further includes at least one dental restorative material 1004, an adhesive material 1006, a polishing material 1008, and a cleaning material 1010. In some embodiments, the cleaning material 1010 may include an alcohol solution. In some embodiments, the kit 1000 further includes one or more labeling plates 1003. In some embodiments, the one or more labeling plates 1003 may be substantially similar to the labeling plate 402 (shown in FIG. 4E). The one or more labeling plates 1003 are configured to be detachably coupled to the bridge member 400. The one or more labeling plates 1003 may be used to identify or label different configurations of the dental model 100.

In some embodiments, the dental restorative material 1004 may include, but is not limited to, a dental porcelain, a zirconia, a glass ceramic, a composite material, a ceramic-composite hybrid material, a resin composite, a metal, a CAD CAM restorative material, and combinations thereof. In some embodiments, the dental restorative material 1004 may include a glass, a polycrystalline ceramic material, for example, including alumina (e.g., Al2O3), zirconia (ZrO2), partly or fully stabilized zirconia (e.g., Yttrium-stabilized zirconia), titanium dioxide (TiO2), high-strength oxides of the elements of the main groups II, III and IV and the subgroups III and IV, and their mixtures, metals, metal alloys, precious metals, precious metal alloys, or combinations thereof (e.g., cobalt alloys, such as cobalt-chromium, titanium alloys, gold/platinum/palladium alloys, etc., and combinations thereof).

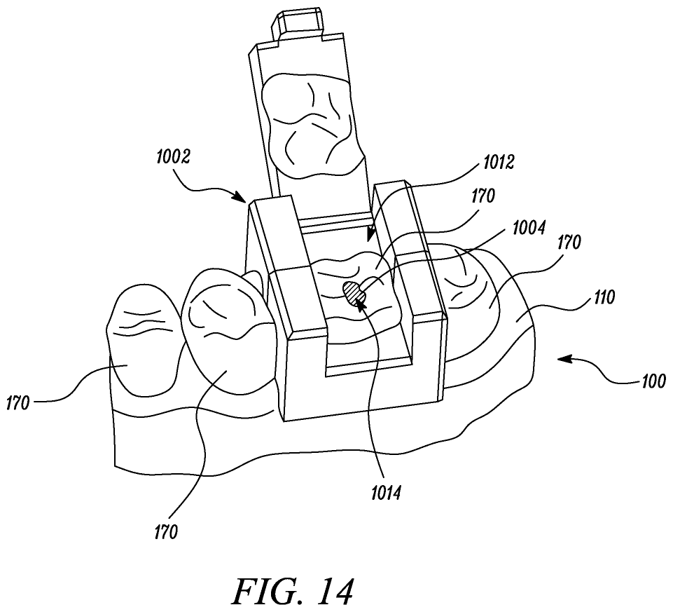

FIG. 14 illustrates a schematic perspective view of one dental matrix 1002 from the one or more dental matrices 1002 coupled to the at least one model tooth 170 according to an embodiment of the present disclosure. In some embodiments, the one or more dental matrices 1002 are configured to couple with at least one of the plurality of model teeth 170 to form a mold cavity 1012 enclosing at least a part of the at least one of the plurality of model teeth 170. In other words, at least one of the plurality of model teeth 170 of the dental model 100 is enclosed by the one or more dental matrices 1002. As discussed above, the dental model 100 may provide realistic simulation of the human dental arch 10. Therefore, the one or more dental matrices 1002 may be precisely placed and register to the fine features of the dental model 100 accurately. This may prevent leakage of the dental restorative material 1004 and damages to the one or more dental matrices 1002 during practice of the composite dental restoration.

The dental matrix 1002 may include a body including as a facial portion, a lingual portion, and an occlusal portion. The dental matrix 1002 may couple to the model tooth 170 to form the mold cavity 1012. The mold cavity 1012 may encompass a missing tooth structure of the model tooth 170. The missing tooth structure of the model tooth 170 may include, for example, a tooth structure removed when preparing the model tooth 170 to remove a carious lesion (or caries). The missing tooth structure may form a cavity 1014 suitable for receiving the dental restorative material 1004 (shown by hatching). Further, at least one of the dental restorative material 1004 is configured to be received within the mold cavity 1012. Specifically, by positioning the one or more dental matrices 1002 over the model tooth 170, the mold cavity 1012 may receive the dental restorative material 1004 to take the form of the missing tooth structure.

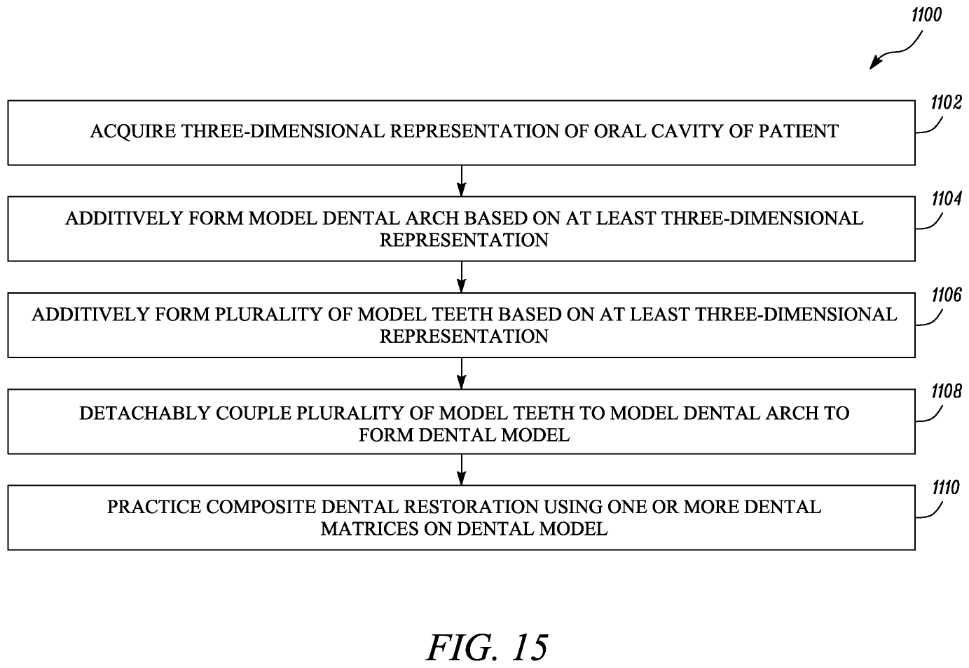

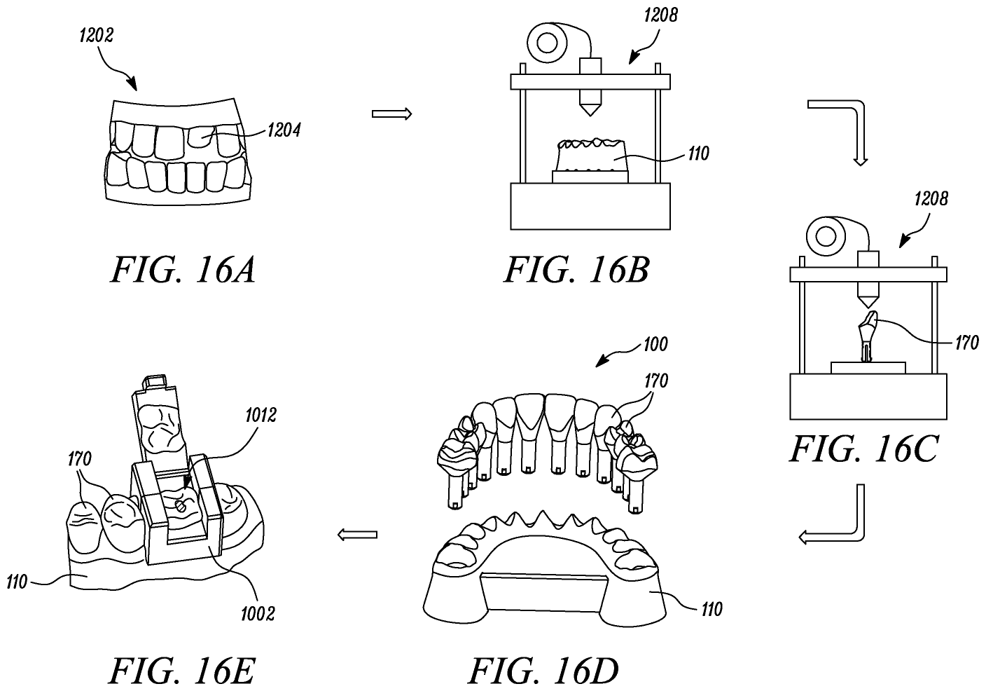

FIG. 15 illustrates a method 1100 of using the dental model 100 (shown in FIGS. 2A and 2B) according to an embodiment of the present disclosure. In some embodiments, the method 1100 may be of using the dental model 200 (shown in FIGS. 8A and 8B). The method 1100 will be described with reference to the dental model 100 of FIGS. 2A-2B and 14. FIGS. 16A-16E illustrate exemplary steps of using the dental model 100. The method 1100 will further be described with reference to FIGS. 16A-16E.

FIG. 16A illustrates a schematic front view of an oral cavity 1202 of a patient. In some embodiments, the method 1100 may include examining the oral cavity 1202 of the patient to determine if a tooth is decayed or disfigured by a dental practitioner. The oral cavity 1202 includes a disfigured tooth 1204.

At step 1102, the method 1100 includes acquiring a three-dimensional representation of the oral cavity 1202 of the patient. In some embodiments, acquiring the three-dimensional representation may further include optically scanning the oral cavity 1202 to obtain scanned data representative of a human dental arch (e.g., the human dental arch 10 shown in FIG. 1). In some embodiments, optically scanning the oral cavity 1202 may further include performing an intraoral scan. In some embodiments, optically scanning the oral cavity 1202 may include performing a digital data capture, a computed tomography (CT), or a computer-aided tomography (CAT) of the oral cavity 1202 of the patient. In some other embodiments, optically scanning the oral cavity 1202 may include indirectly performing a digital data capture of the oral cavity 1202 of the patient by performing the digital data capture of a plaster model of the oral cavity 1202 of the patient or of a dental impression of the oral cavity 1202 of the patient, rather than directly capturing a three-dimensional structure of the oral cavity 1202 of the patient. In the case of using the dental impression, the digital data capture may be inverted from a negative volume to a positive volume.

In some embodiments, the method 1100 may include temporarily restoring the disfigured tooth 1204 of the patient for a desired final shape of the disfigured tooth 1204. In some embodiments, temporarily restoring the decayed or disfigured tooth 1204 may include placing a repair (not shown) on the decayed or disfigured tooth 1204. In some embodiments, the three-dimensional representation of the oral cavity of 1202 is acquired after temporarily restoring the decayed or disfigured tooth 1204.

In some embodiments, acquiring the three-dimensional representation may further include processing the scanned data to generate the three-dimensional representation of the oral cavity 1202. In some other embodiments, acquiring the three-dimensional representation may further include retrieving the three-dimensional representation of the oral cavity 1202 from a database. In some embodiments, at least a portion of the three-dimensional representation may be provided by a series of tooth libraries, or databases, that may be adapted to replicate at least a portion of the oral cavity 1202. Use of the database may be necessary for a severely worn, fractured, or altogether absent tooth, for example, the disfigured tooth 1204. In some embodiments, the three-dimensional representation may be provided by the patient's file history or from a previous digital data capture.

At step 1104, the method 1100 further includes forming (shown in FIG. 16B) the model dental arch 110. In the illustrated embodiment of FIG. 16B, the method 1100 further includes additively forming the model dental arch 110 based on at least the three-dimensional representation. In some embodiments, additively forming the model dental arch 110 includes integrally forming the first member 120 and the second member 140.

In some other embodiments, additively forming the model dental arch 110 includes separately forming the first member 120 and the second member 140. In such embodiments, the method 1100 further includes slidably coupling the first member 120 and the second member 140.

However, in some other embodiments, the method 1100 may further include forming the model dental arch 110 using an injection molding process based on at least the three-dimensional representation.

At step 1106, the method 1100 further includes forming (shown in FIG. 16C) the plurality of model teeth 170. In the illustrated embodiment of FIG. 16C, the method 1100 further includes additively forming the plurality of model teeth 170 based on at least the three-dimensional representation. However, in some embodiments, the method 1100 may further include forming the plurality of model teeth 170 using the injection molding process based on at least the three-dimensional representation.

In the illustrated embodiments of FIGS. 16B and 16C, an exemplary additive manufacturing apparatus 1208 is used for forming the model dental arch 110 and the plurality of model teeth 170. In some embodiments, the model dental arch 110 and the plurality of model teeth 170 may be additively formed using an additive manufacturing technique, such as stereolithography (SLA). Other examples of additive manufacturing techniques include Fused Filament Fabrication (FFF), Powder Bed Fusion (PBF), and the like. In SLA, successive layers of material may be laid down by the additive manufacturing apparatus 1208 under control of a computer (not shown). In some embodiments, the computer may include a display and one or more user input devices, such as a mouse or a keyboard. In some embodiments, the additive manufacturing apparatus 1208 may also include an input device or an output device, such as a control input (e.g., button, touchpad, thumbwheel, etc.), or a display (e.g., LCD or LED display) to provide status information.

In some other embodiments, an injection molding apparatus may be used for forming the model dental arch 110 and the plurality of model teeth 170.

In some embodiments, the method 1100 further includes additively forming the one or more dental matrices 1002 based on at least the three-dimensional representation.

In some other embodiments, the method 1100 may further include forming the one or more dental matrices 1002 using the injection molding process based on at least the three-dimensional representation.

At step 1108, the method 1100 further includes detachably coupling (shown in FIG. 16D) the plurality of model teeth 170 to the model dental arch 110 to form the dental model 100. Each of the plurality of model teeth 170 is at least partially and slidably received in the respective first and second openings 122, 142 (shown in FIGS. 3B-3C and 4A-4C) of the first member 120 (shown in FIGS. 3A-3C) and the second member 140 (shown in FIGS. 4A-4C).

At step 1110, the method 1100 further includes practicing (shown in FIG. 16E) the composite dental restoration using the one or more dental matrices 1002 on the dental model 100.

In some embodiments, practicing the composite dental restoration using the one or more dental matrices 1002 on the dental model 100 includes coupling the one or more dental matrices 1002 with at least one of the plurality of model teeth 170 to form the mold cavity 1012 enclosing at least a part of the at least one of the plurality of model teeth 170. Further, practicing the composite dental restoration using the one or more dental matrices 1002 on the dental model 100 includes at least partially filling the mold cavity 1012 with the dental restorative material 1004.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A dental model comprising:
a model dental arch comprising:
a first member representative of a human dental arch and comprising a plurality of first openings therethrough, wherein each of the plurality of first openings extends along a longitudinal axis, and wherein the first member comprises a first material having a first elastic modulus; and
a second member at least partially received within the first member, the second member comprising a plurality of second openings extending therethrough, wherein the plurality of first openings of the first member and the plurality of second openings of the second member are aligned to each other in a one-to-one correspondence, and wherein the second member comprises a second material having a second elastic modulus; and
a plurality of model teeth corresponding to a plurality of human teeth, wherein each of the plurality of model teeth comprises a tooth portion representative of a corresponding human tooth from the plurality of human teeth and a connecting portion extending from the tooth portion, wherein the tooth portion of each of the plurality of model teeth is at least partially and slidably received in a respective first opening from the plurality of first openings, and wherein the connecting portion of each of the plurality of model teeth is at least partially received in a respective second opening from the plurality of second openings and detachably retained in the respective second opening;
wherein at least one of:
the tooth portion of each of the plurality of model teeth and at least a portion of a surface of the first member forming the respective first opening define a clearance therebetween; and
the first elastic modulus of the first material is from about 0.1 MPa to about 5 MPa;
such that upon application of a lateral load on each of the plurality of model teeth in a direction substantially perpendicular to the longitudinal axis, each of the plurality of model teeth flexes laterally from at least about 50 microns to at most about 250 microns in the direction substantially perpendicular to the longitudinal axis.

2. (canceled)

3. The dental model of claim 1, wherein the second elastic modulus of the second material is from about 750 MPa to about 20000 MPa.

4. The dental model of claim 1, wherein each of the plurality of model teeth comprises a third material having a third elastic modulus, wherein the third elastic modulus is equal to about the second elastic modulus.

5. The dental model of claim 1, wherein the second elastic modulus is equal to about the first elastic modulus.

6. The dental model of claim 1, wherein a ratio of the second elastic modulus to the first elastic modulus is at least 10.

7. The dental model of claim 1, wherein a ratio of the second elastic modulus of the second material to the first elastic modulus of the first material is from about 150 to about 200000.

8. The dental model of claim 1, wherein the tooth portion of each of the plurality of model teeth comprises an outer surface, and wherein a shape of the surface of the first member forming the respective first opening is at least partially similar to a shape of the outer surface of the tooth portion.

9. The dental model of claim 1, further comprising a low modulus material at least partially filling the clearance, wherein the low modulus material has an elastic modulus of at most about 20% of the second elastic modulus.

10. The dental model of claim 1, wherein each of the plurality of second openings comprises a first portion having a first width and a second portion disposed adjacent to the first portion and having a second width, wherein the second width of the second portion is greater than the first width of the first portion, wherein the second member comprises a plurality of retaining surfaces corresponding to the plurality of second openings, and wherein each retaining surface extends between the first portion and the second portion of the corresponding second opening, and wherein the second member comprises a plurality of tubular segments corresponding to the plurality of second openings, each tubular segment comprising a narrow part defining the first portion of the respective second opening from the plurality of second openings and a wide part defining the second portion of the respective second opening, and wherein each tubular segment is at least partially received within the respective first opening from the plurality of first openings.

11. (canceled)

12. The dental model of claim 10, wherein the connecting portion of each of the plurality of model teeth comprises a pair of retention legs, and wherein the pair of retention legs define a slot therebetween, such that the pair of retention legs resiliently move towards each other upon insertion of the pair of retention legs into the first portion of the respective second opening, wherein each of the pair of retention legs further comprises at least one protrusion, such that the at least one protrusion engages the retaining surface of the respective second opening, and wherein the at least one protrusion comprises an entrance end configured to be received within the second portion of the respective second opening and a retention end configured to engage with the retaining surface, and wherein a width of the retention end is greater than a width of the entrance end.

13-14. (canceled)

15. The dental model of claim 10, wherein a maximum width of the connecting portion of each of the plurality of model teeth is at least about 95% of the first width of the first portion of the respective second opening.

16. The dental model of claim 10, wherein a maximum width of the connecting portion of each of the plurality of model teeth is at most about 75% of the first width of the first portion of the respective second opening.

17. The dental model of claim 1, further comprising a bridge member connected to two or more spaced apart locations on the model dental arch.

18-22. (canceled)

23. The dental model of claim 1, wherein the model dental arch further comprises a bottom surface distal to the tooth portion of each of the plurality of model teeth, and wherein the bottom surface defines a plurality of channels.

24-26. (canceled)

27. A dental model comprising:
a model dental arch representative of a human dental arch and comprising a plurality of openings therethrough, wherein each of the plurality of openings extends along a longitudinal axis, and wherein the model dental arch comprises a material having an elastic modulus; and
a plurality of model teeth corresponding to a plurality of human teeth, wherein each of the plurality of model teeth comprises a tooth portion representative of a corresponding human tooth from the plurality of human teeth and a connecting portion extending from the tooth portion, wherein the tooth portion and the connecting portion of each of the plurality of model teeth is at least partially and slidably received in a respective opening from the plurality of openings, and wherein the connecting portion of each of the plurality of model teeth is detachably retained in the respective opening;
wherein:
the tooth portion of each of the plurality of model teeth and at least a portion of a surface of the model dental arch forming the respective opening define a clearance therebetween; or
the tooth portion of each of the plurality of model teeth and at least the portion of the surface of the model dental arch forming the respective opening define the clearance therebetween and the elastic modulus of the material is from about 750 MPa to about 20000 MPa; or
the elastic modulus of the material is from about 0.1 MPa to about 5 MPa; or
the tooth portion of each of the plurality of model teeth and at least the portion of the surface of the model dental arch forming the respective opening define the clearance therebetween and the elastic modulus of the material is from about 0.1 MPa to about 5 MPa;
such that upon application of a lateral load on each of the plurality of model teeth in a direction substantially perpendicular to the longitudinal axis, each of the plurality of model teeth flexes laterally from at least about 50 microns to at most about 250 microns in the direction substantially perpendicular to the longitudinal axis.

28. (canceled)

29. (canceled)

30. The dental model of claim 27, further comprising a low modulus material at least partially filling the clearance, wherein the low modulus material has an elastic modulus less than the elastic modulus of the material of the model dental arch.

31. The dental model of claim 27, wherein each of the plurality of openings comprises a first portion having a first width and a second portion disposed adjacent to the first portion and having a second width, wherein the second width of the second portion is greater than the first width of the first portion, wherein the model dental arch comprises a plurality of retaining surfaces corresponding to the plurality of openings, and wherein each retaining surface extends between the first portion and the second portion of the corresponding opening, wherein the connecting portion of each of the plurality of model teeth comprises a pair of retention legs, wherein the pair of retention legs define a slot therebetween, such that the pair of retention legs resiliently move towards each other upon insertion of the pair of retention legs into the first portion of the respective opening, wherein each of the pair of retention legs further comprises at least one protrusion, such that the at least one protrusion engages the retaining surface of the respective opening, and wherein the at least one protrusion comprises an entrance end configured to be received within the second portion of the respective opening and a retention end configured to engage with the retaining surface, and wherein a width of the retention end is greater than a width of the entrance end.

32-44. (canceled)

45. A dental kit for practicing composite dental restoration, the kit comprising:
the dental model of claim 1; and
one or more dental matrices configured to couple with at least one of the plurality of model teeth to form a mold cavity enclosing at least a part of the at least one of the plurality of model teeth.

46. The dental kit of claim 45, further comprising at least one of a dental restorative material configured to be received within the mold cavity, an adhesive material, a polishing material, and a cleaning material.

47. The dental kit of claim 45, wherein the dental model comprises a bridge member connected to two or more spaced apart locations on model dental arch, and further comprising one or more labeling plates, wherein the one or more labeling plates are configured to be detachably coupled to the bridge member.

48-58. (canceled)
